(19) United States
(12) Patent Application Publication
(10) Pub. No.: US 2025/0298145 A1
(43) Pub. Date: Sep. 25, 2025

(54) Position Estimation Using a Modeled Loss Function

(71) Applicant: NextNav France, Puteaux (FR)

(72) Inventors: Rabih CHRABIEH, Montrouge (FR); Minh HOANG, Fontenay-aux-Roses (FR)

(73) Assignee: NextNav France, Puteaux (FR)

(21) Appl. No.: 18/756,421

(22) Filed: Jun. 27, 2024

Related U.S. Application Data
(60) Provisional application No. 63/568,554, filed on Mar. 22, 2024.

(51) Int. Cl. G01S 19/07

(52) U.S. Cl. CPC G01S 19/07

(57) ABSTRACT

A method involves collecting first positioning data associated with multiple positioning data quality metrics within a region. One or more modeled loss functions associated with each positioning data quality metric are determined using the first positioning data. The modeled loss functions are stored at a database. A first estimated position of a computing device is determined using second positioning data. A modeled loss function that is associated with a positioning data quality metric associated with the second positioning data is retrieved from the database. A first gradient descent process is performed using the first estimated position and the retrieved modeled loss function to determine an estimated clock bias for the computing device. A second gradient descent process using the first estimated position, the estimated clock bias, and the retrieved modeled loss function is performed to determine a second estimated position for the computing device.

### RELATED APPLICATIONS

This application claims priority to U.S. Provisional Patent Application No. 63/568,554, filed Mar. 22, 2024, all of which is incorporated herein in its entirety.

### BACKGROUND

Determining the exact location of a computing device, such as a fixed device or a mobile device (e.g., a phone, laptop computer, tablet, or another device) in an environment can be quite challenging, especially when the computing device is located in an urban environment or is located within a building. Imprecise estimates of the computing device's position may have “life or death” consequences for the user. For example, an imprecise position estimate of a computing device, such as a mobile phone operated by a user calling 911, can delay emergency personnel response times. In less dire situations, imprecise estimates of the computing device's position can negatively impact navigation applications by directing a user to the wrong location or taking too long to provide accurate directions.

Multilateration is a widely used technique to determine the position of a computing device. This is achieved by measuring the time delay or signal strength from multiple known points, such as satellites in Global Navigation Satellite Systems (GNSS) or cell towers. As mentioned above, the accuracy and reliability of location estimation are critical, especially in applications like navigation, emergency services, and location-based services.

Multilateration involves solving a set of mathematical equations derived from the distances between the computing device and each of the known points (“anchors”). These distances are typically calculated based on the time of arrival (TOA), time difference of arrival (TDOA), or received signal strength (RSS) of the signals emitted by the satellites or cell towers.

A key challenge in the multilateration process is dealing with inaccuracies and errors in signal measurements, which can be due to various factors like atmospheric conditions, multipath propagation, and signal obstructions in urban environments. To address this, the concept of a loss function becomes vital. A loss function in the context of multilateration is a mathematical formulation used to quantify the error or discrepancy between the estimated position of the computing device and its actual position. The primary objective of employing a loss function is to minimize this error during the process of location estimation. The loss function plays a crucial role in refining the algorithms used for position calculation, enabling them to accommodate and adjust for measurement inaccuracies and uncertainties.

### SUMMARY

In some aspects, the techniques described herein relate to a method including: collecting, by one or more processors, first positioning data associated with multiple positioning data quality metrics within a region; determining, by the one or more processors, one or more modeled loss functions associated with each positioning data quality metric using the collected first positioning data; storing, by the one or more processors, the one or more modeled loss functions at a database; determining, by the one or more processors, a first estimated position of a computing device using second positioning data; retrieving from the database, by the one or more processors, a modeled loss function of the one or more modeled loss functions, the retrieved modeled loss function being associated with a positioning data quality metric associated with the second positioning data; performing, by the one or more processors, a first gradient descent process using the first estimated position and the retrieved modeled loss function to determine an estimated clock bias for the computing device; and performing, by the one or more processors, a second gradient descent process using the first estimated position, the estimated clock bias, and the retrieved modeled loss function to determine a second estimated position for the computing device, the second estimated position being a more accurate estimated position of the computing device as compared to the first estimated position of the computing device.

In some aspects, the techniques described herein relate to a method including: collecting, by one or more processors, first positioning data associated with multiple positioning data quality metrics within a region; determining, by the one or more processors, one or more modeled loss functions associated with each positioning data quality metric using the collected first positioning data; storing, by the one or more processors, the one or more modeled loss functions at a database; determining, by the one or more processors, a first estimated position of a computing device using second positioning data; retrieving from the database, by the one or more processors, a modeled loss function of the one or more modeled loss functions, the retrieved modeled loss function being associated with a positioning data quality metric associated with the second positioning data; and determining, by the one or more processors, a second estimated position for the computing device using the retrieved modeled loss function, the second estimated position being a more accurate estimated position of the computing device as compared to the first estimated position of the computing device.

### BRIEF DESCRIPTION OF THE DRAWINGS

FIG. 1 is a simplified operational environment for position estimation using a modeled loss function, in accordance with some embodiments.

FIG. 2 is a simplified portion of a process for position estimation using a modeled loss function, in accordance with some embodiments.

FIG. 3 is a simplified portion of the process shown in FIG. 2 for position estimation using a modeled loss function, in accordance with some embodiments.

FIG. 4 is a simplified portion of the process shown in FIG. 3 for position estimation using a modeled loss function, in accordance with some embodiments.

FIGS. 5A-B illustrate attributes of a Type A loss function, in accordance with some embodiments.

FIGS. 6A-B illustrate attributes of a Type B loss function, in accordance with some embodiments.

FIGS. 7A-B illustrate attributes of a Type C loss function, in accordance with some embodiments.

FIG. 8 is a graph of empirically derived Cumulative Distribution Functions of residuals, in accordance with some embodiments.

FIGS. 9A-B illustrate attributes of an empirically derived loss function, in accordance with some embodiments.

FIGS. 10-15 illustrate portions of the process for determining a modeled loss function, in accordance with some embodiments.

FIG. 16 provides implementation details of an example transmitter, computing device, and server introduced in FIG. 1, in accordance with some embodiments.

### DETAILED DESCRIPTION

Multilateration to find an estimated position of a target (e.g., a computing device such as a cellular phone, laptop, tablet, vehicle, etc.) often involves minimizing a single loss function, or the sum of multiple loss functions. Given a set of observations from several anchors (transmitters or receivers), the loss function(s) are used to determine what position, e.g., (x, y, z) is the most likely one for the target. Each observation is called a pseudorange. The pseudorange is a function of i) a signal's time of arrival at the target, ii) the distance from the anchor to the target, iii) a clock bias in the target, and iv) random noise with some statistics generated by the receiver and the transmitter. The pseudorange is also dependent on multipath and effects from non-line-of-sight (NLOS) signal reception.

The estimated noise for a given hypothesis on position and clock bias is referred to herein as a residual. For simplicity of the description herein, it is assumed that the anchors' clocks are synchronized, or their clocks can be corrected by other means (e.g., ephemeris from GNSS signals, base station almanacs in LTE or 5G-NR systems).

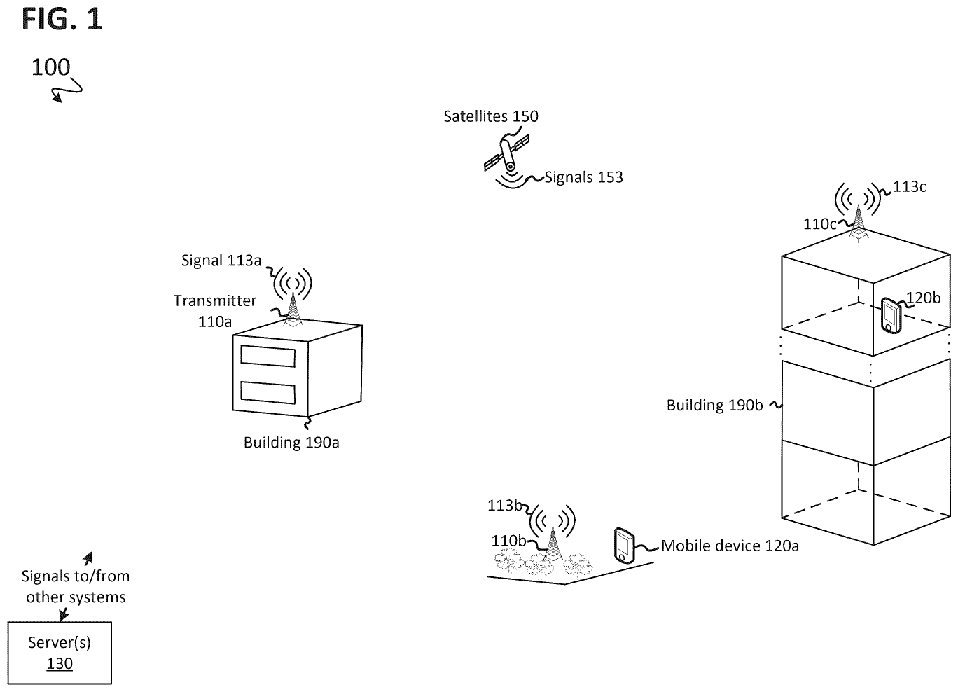

Attention is initially drawn to an operational environment 100 for position estimation of a target, such as a computing device, in FIG. 1, in accordance with some embodiments. The operational environment 100 contains a network of terrestrial transmitters 110a-c (i.e., anchors), any number of computing devices 120a-b (i.e., targets), any number of buildings 190a-b, any number of satellites 150, and any number of servers 130. Also shown are ranging signals 113a-c associated with the respective transmitters 110a-c, and ranging signals 153 associated with the satellites 150.

The transmitters 110a-c and the computing devices 120a-b may be located at different altitudes or depths that are inside or outside various natural or manmade structures (e.g., the buildings 190a-b). The signals 113a-c and 153 are exchanged between the computing devices 120a-b, the transmitters 110a-c, and the satellites 150 using known wireless or wired transmission technologies. The transmitters 110a-c may transmit the signals 113a-c using one or more common multiplexing parameters-e.g., time slot, pseudorandom sequence, or frequency offset. The servers 130 and the computing devices 120a-b may exchange information with each other.

The satellites 150 may be part of a GNSS (Global Navigation Satellite System) which may include other existing satellite positioning systems such as Glonass as well as future positioning systems such as Galileo and Compass/Beidou. The transmitters 110a-c may be synchronized beacons of a wide area positioning system and may form a CDMA or OFDMA network. Each of the transmitters 110a-c may be operable to transmit a Pseudo Random Number (PRN) sequence with good cross-correlation properties such as a Gold Code sequence with a data stream of embedded assistance data. Alternatively, wireless signals transmitted by the transmitters 110a-c may be staggered in time into separate slots in a TDMA format. The computing devices 120a-b are operable to receive ranging signals using a wireless position signal receiver and to determine an estimated 2D or 3D position thereof based on time of arrival estimates of the received signal using multilateration techniques as disclosed herein.

Because of regionally specific characteristics, such as the topology of an urban environment, the specific distribution of the transmitters 110a-c within the region, multipath effects, and noise, a general loss function may not be ideal for multilateration. Disclosed herein are processes for modeling one or more loss functions based on empirically derived data for a specific region to improve the speed and precision of multilateration of computing devices within that region.

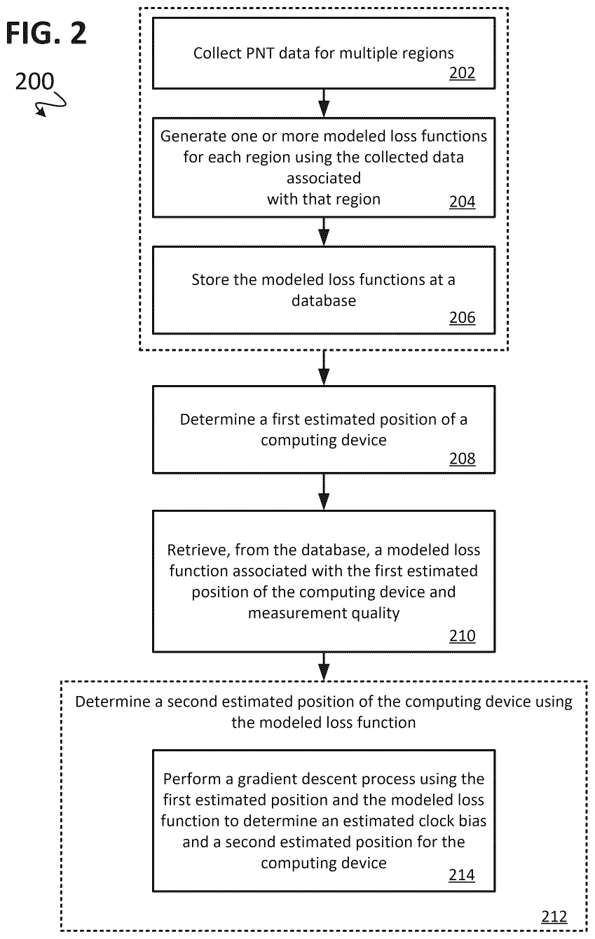

FIG. 2 shows a simplified portion of an example process for position estimation of a computing device using one or more modeled loss functions, in accordance with some embodiments. The particular steps, order of steps, and combination of steps are shown for illustrative and explanatory purposes only. Other embodiments can implement different particular steps, orders of steps, and combinations of steps to achieve similar functions or results. The following steps may be performed at one or more servers and/or at a computing device.

At step 202, positioning, navigation and/or timing (PNT) data associated with multiple regions is collected by one or more processors (e.g., at the servers 130 and/or the computing devices 120a-b) using the computing devices 120a-b, signal monitoring units (not shown), crowdsourced data, surveyed data, etc. At step 204, as described in detail below, one or more modeled loss functions associated with each region and one or more signal quality metrics (also referred to herein as positioning data quality metrics) of measurements (e.g., signal strength, signal-to-noise ratio (SNR), multi-path effects, etc.) are generated by one or more processors using the collected data. For example, a high-quality SNR or a high signal power measurement is assigned to a different loss function as compared to another measurement having a low SNR or a low received power. As described herein, this assignment is represented by the ‘q’ index for quality (but may also represent a different region, like urban, rural, etc.).

At step 206, the modeled loss functions are stored by the one or more processors at one or more databases. Thus, steps 202, 204, and 206 may be considered to be preliminary “offline” steps for position estimation of a computing device.

At step 208, a first estimated position of a computing device is determined by the one or more processors (e.g., using multilateration techniques in conjunction with the signals 113a-c and/or 153). At step 210, a modeled loss function associated with the first estimated position of the computing device is retrieved by the one or more processors from the one or more databases mentioned at step 206 upon determining that the first estimated position of the computing device is within a region having a quality of measurements associated with the retrieved modeled loss function.

At step 212, a second estimated position of the computing device is determined using the retrieved modeled loss function. In some embodiments, the second estimated position of the computing device is determined using conventional multilateration techniques in conjunction with the modeled loss function rather than a conventional or regionally generic loss function. In other embodiments, the second estimated position of the computing device is determined using a gradient descent method as part of optional step 214.

A step 214, the second estimated position of the computing device and a first clock bias estimate of the computing device are determined using the retrieved modeled loss function and the first estimated position based on a gradient descent process, the second estimated position of the computing device being a more accurate position estimate as compared to the first position estimate of the computing device due to the use of the modeled loss function (i.e., a regionally or situationally specific loss function). In some embodiments, step 214 is then reiterated to find a third estimated position of the computing device and a second clock bias estimate, the third estimated position of the computing device being a more accurate position estimate as compared to the second estimated position of the computing device and the second clock bias estimate being a more accurate clock bias estimate as compared to the first clock bias estimate. In some embodiments, separate gradient descent processes are conducted by the server to determine the position estimates and the clock bias estimates. In other embodiments, the one or more processors converge on both at once by following a gradient that includes both the position estimates and the clock bias estimates.

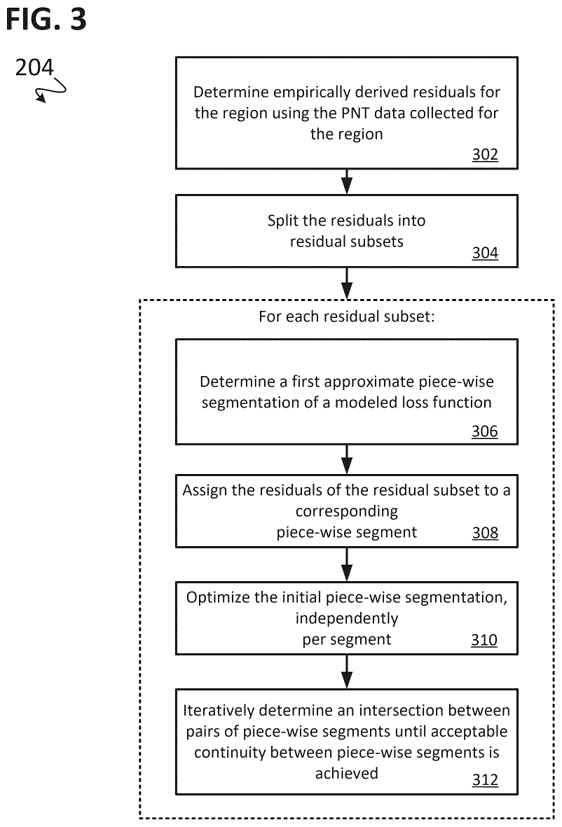

FIG. 3 shows a simplified portion of an example process for determining one or more modeled loss functions for each region using the collected data associated with that region and measurement quality as introduced in step 204 of the process 200, in accordance with some embodiments. The particular steps, order of steps, and combination of steps are shown for illustrative and explanatory purposes only. Other embodiments can implement different particular steps, orders of steps, and combinations of steps to achieve similar functions or results. The following steps may be performed at one or more servers and/or at a computing device.

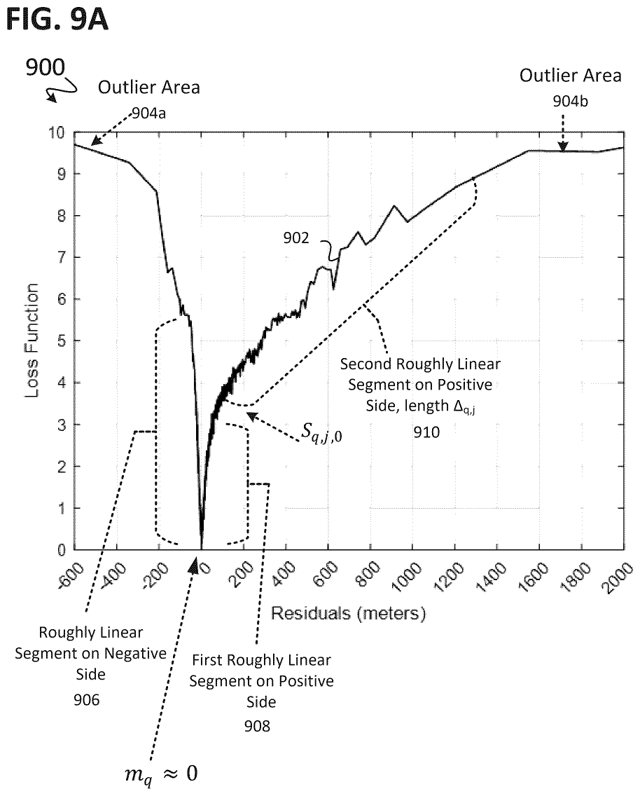

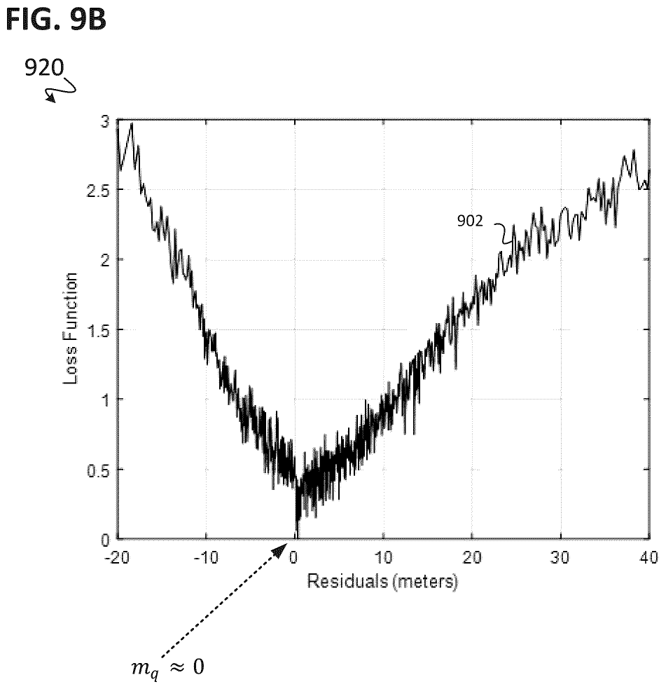

At step 302, empirically derived position estimation residuals are determined by a server for a region using the PNT data collected for that region at step 202. At step 304, the server splits the resultant residuals into residual subsets based on one or more signal quality metrics and/or regions. Such splitting is discussed below with reference to FIG. 9A. At step 306, the server determines a first approximate segmentation of the modeled loss function using the residual subsets.

Steps 306, 308, 310, and 312 are then performed by the server for each of the residual subsets. At step 308, the server assigns the residuals of the residual subset to a corresponding piece-wise segment. At step 310, the server optimizes the initial piece-wise segmentation, independently per segment. At step 312, the server iteratively determines an intersection between pairs of piece-wise segments until a local optimal segmentation is found, and afterward until acceptable continuity between the piece-wise segments is achieved.

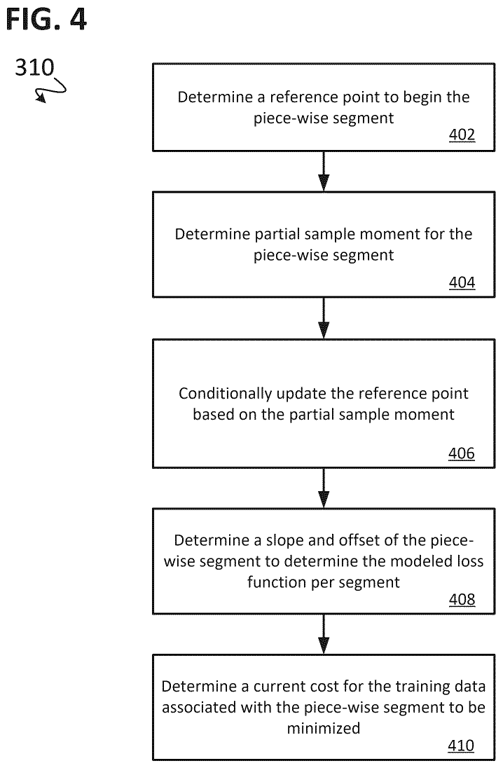

FIG. 4 shows a simplified portion of an example process for optimizing for the initial piece-wise segmentation of the modeled loss function, independently per piece-wise segment, as introduced in sub-step 310 of step 204 of the process 200, in accordance with some embodiments. The particular steps, order of steps, and combination of steps are shown for illustrative and explanatory purposes only. Other embodiments can implement different particular steps, orders of steps, and combinations of steps to achieve similar functions or results. The following steps may be performed at one or more servers and/or at a computing device.

At step 402, the server determines a suitable reference point for the given piece-wise segment, such as the beginning, end, or middle of the segment. At step 404, the server determines a partial sample moment for the piece-wise segment. In probability and statistics, moments are quantitative measures related to the shape of a function's graph, particularly the probability distribution or probability density function.

At step 406, the server conditionally updates the initial reference point based on the partial sample moment. At step 408, the server determines a slope and offset of the piece-wise segment, i.e., the loss function within the segment. At step 410, the server determines a current cost for the training data associated with the piece-wise segment to be minimized (as described in detail below).

Details of the process 200 are described below using the following notation: scalars or functions x, N (italic, non-boldface), vectors x (non-italic, boldface, small letter), matrixes X (non-italic, boldface, capital letter). Superscript T denotes the matrix transpose as in X^{T}.

The pseudorange model used in multilateration for an observation i, where superscript t denotes ground truth position (i.e., the actual position) or clock bias truth, may be expressed as

$${ρ}_{i} = {d}_{i}^{t} + {b}^{t} + {n}_{i} , \qquad ( Equation 1 )$$

where b is a clock bias, and

$${d}_{i} = \sqrt{{( x - {x}_{i} )}^{2} + {( y - {y}_{i} )}^{2} + {( z - {z}_{i} )}^{2} ,} \qquad ( Equation 2 )$$

is the distance from the target computing device (x, y, z) to an anchor i (e.g., a transmitter 110a-c and/or satellite 150) given by (xᵢ, yᵢ, zᵢ). The ground truth position for the computing device (e.g., the computing device 120a-b) is denoted as (x^{t}, y^{t}, z^{t}), and its clock bias truth is b^{t}. Without superscript t, the unknowns dᵢ(x, y, z), b are hypotheses. The pseudorange ρᵢ is estimated and known, but it is noisy.

The residual of a measurement, particularly in the context of multilateration and similar estimation problems, refers to the difference between the observed values and the values predicted or estimated by the model. The residual (or estimated noise \hat{n}ᵢ) for a given hypothesis on distance or position (x, y, z), and clock bias b may be expressed as

$${r}_{i} = {ρ}_{i} - {d}_{i} - b , \qquad ( Equation 3 )$$

where ρᵢ is the pseudorange observation, and dᵢ(x, y, z) and b are unknowns to be estimated. That is, rᵢ(x, y, z, b) is a function of the unknown parameters to be determined.

A loss function L_{q}(rᵢ), such as Least Squares (LS), w_{q}|rᵢ|², or Least Absolute Deviations (LAD), w_{q}|rᵢ|, is typically used to minimize a cost function given multiple residual observations, i.e.,

$${min}_{x , y , z , b} {\sum }_{i} {L}_{q} ( {r}_{i} ) , \qquad ( Equation 4 )$$

which leads to an estimate of x, y, z, and b. The integer index q=q(rᵢ) above denotes which loss function is being used given the measurement quality (e.g., based on signal strength, SNR, region, and/or other signal quality metrics), or some features, of the residual rᵢ. The loss function is parameterized by the estimated quality of the residual, e.g., by a weight w_{q}, with stronger weight values being used for higher-quality residuals. The sum of the loss functions is denoted by

$$L ( r ) = {\sum }_{i} {L}_{q} ( {r}_{i} ) , \qquad ( Equation 5 )$$

with residuals vector r=(r₀, r₁, r₂, . . . ). The sum of the separate loss functions is then minimized, where each loss function corresponds to one observation (e.g., one pseudorange). Note that the sum of the loss functions is itself a loss function or cost function and corresponds to all the observations.

The preceding observation is equivalent to maximizing the probability of observing the set of the residuals rᵢ, i.e.,

$$max \prod exp ( - {L}_{q} ( {r}_{i} ) ) , \qquad ( Equation 6 )$$

which is also known as a Maximum Likelihood (ML) estimation if exp(−L_{q}(rᵢ)) correctly models the noise probability distributions.

In one example, the loss function is expressed as the negative log of a likelihood function, such as a Probability Distribution Function (PDF). The Cumulative Distribution Function (CDF) and PDF of a residual rᵢ are respectively denoted herein by C_{q}(rᵢ), and P_{q}(rᵢ). Thus, the ML solution using the PDF may be expressed as,

$${L}_{q} ( {r}_{i} ) \approx - log {P}_{q} ( {r}_{i} ) , \qquad ( Equation 7 )$$

where the PDF is expressed as

$${P}_{q} ( {r}_{i} ) = \frac{{dC}_{q} ( {r}_{i} )}{{dr}_{i}} , \qquad ( Equation 8 )$$

i.e.,

$${L}_{q} ( {r}_{i} ) \approx - log \frac{{dC}_{q} ( {r}_{i} )}{{dr}_{i}} . \qquad ( Equation 9 )$$

In some embodiments, there is an option to add a different constant to each loss function L_{q}, or to multiply each loss function L_{q} by the same positive constant as this does not change the relative position of the minima of the expression, i.e.,

$${min}_{x , y , z , b} {\sum }_{i} {L}_{q} ( {r}_{i} ) = {min}_{x , y , z , b} {\sum }_{i} α ( {L}_{q} ( {r}_{i} ) + {β}_{q} ) , \qquad ( Equation 10 )$$

where α>0, and α and β_{q} are constants.

In some embodiments, only a particular family of loss functions are considered, i.e., those having a unique minimum (i.e., PDFs that have a unique maximum, or are unimodal), and that strictly monotonically decrease to the minimum and then strictly monotonically increase after the minimum.

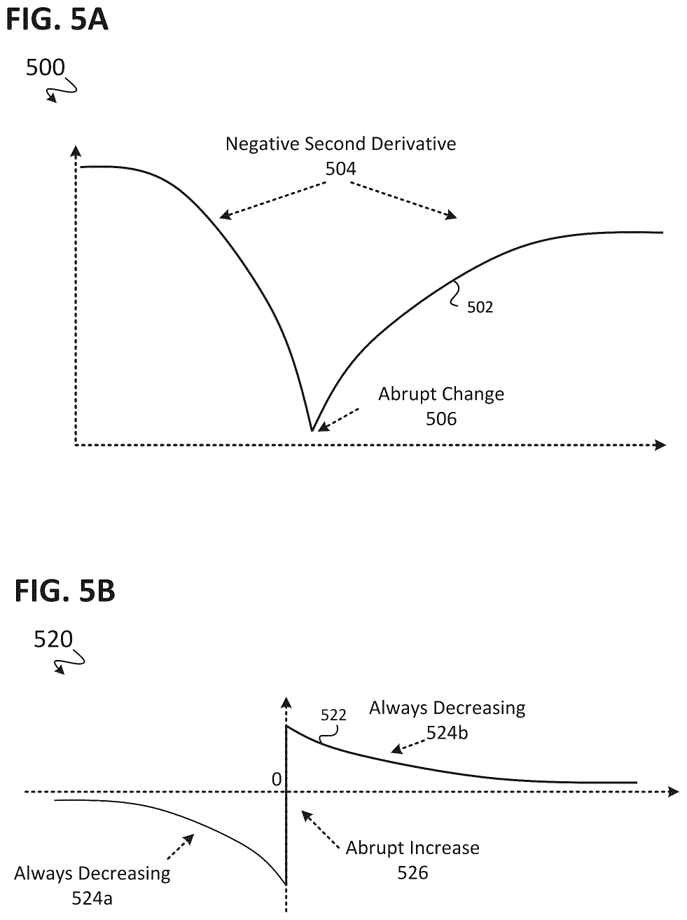

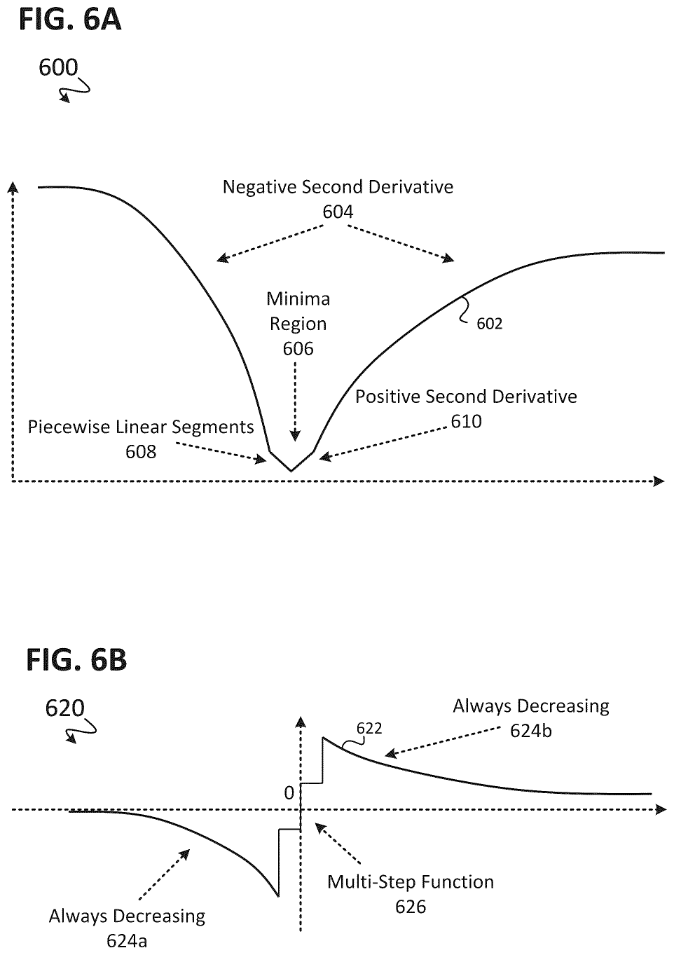

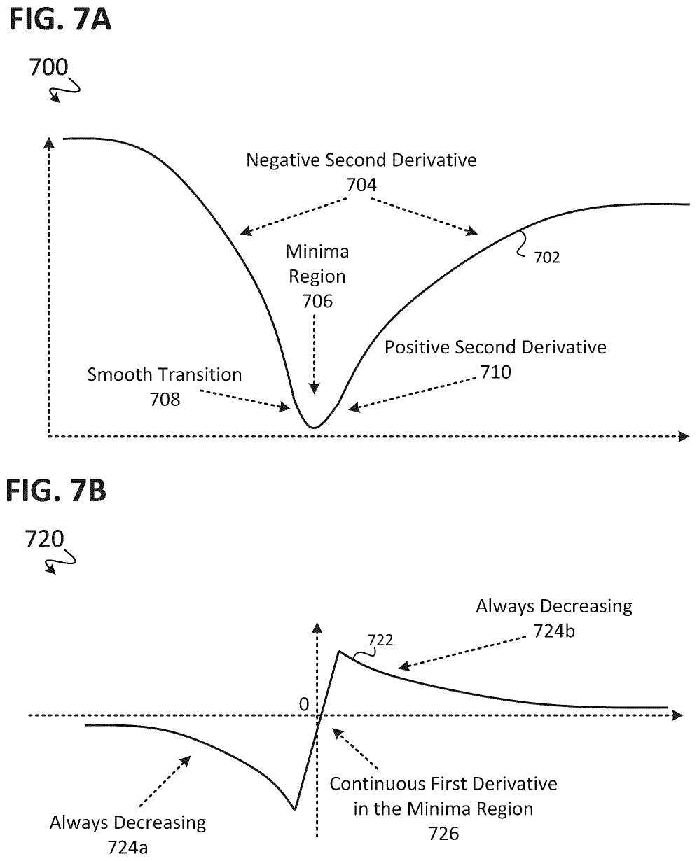

Such loss functions are advantageously representative of typical multipath and noise probability distributions for ranging signals. Furthermore, of that family of loss functions, only particular loss functions are considered herein, i.e., those whose derivative is strictly decreasing except at the position of the minimum, where the derivative ϕ_{q}(rᵢ) abruptly increases before decreasing again. Such loss functions are illustrated in FIGS. 5A-B, FIGS. 6A-B, and FIGS. 7A-B.

FIG. 5A shows a simplified plot 500 of a first type of loss function 502 considered herein, in accordance with some embodiments. The loss function 502 models typical exponentials in multipath channels, and is denoted herein as a “Type A” loss function. As shown, the loss function 502 is characterized by regions 504 having a negative second derivative, and an abrupt change at minima 506.

FIG. 5B shows a simplified plot 520 of a first derivative 522 of the loss function 502, in accordance with some embodiments. As shown, the first derivative 522 is characterized by regions 524a-b which are always decreasing, and an abrupt increase 526. This implies that the second derivative is always negative (and positive infinity at the left/right limit of the position of the minimum). Optionally, a small region surrounding the minimum can be modeled as a “trust region” (e.g., using an L1 Norm or L2 Norm).

FIG. 6A shows a simplified plot 600 of a second type of loss function 602 considered herein, in accordance with some embodiments. The loss function 602 is denoted herein as a “Type B” loss function. As shown, the loss function 602 is characterized by regions 604 having a negative second derivative, and a minima region 606 which is modeled by piecewise linear segments 608. A linear segment 610 is characterized by a positive second derivative.

FIG. 6B shows a simplified plot 620 of a first derivative 622 of the loss function 602. As shown, the first derivative 622 is characterized by regions 624a-b which are always decreasing, and an increasing multi-step function 626 corresponding to the linear segments 608 and 610.

FIG. 7A shows a simplified plot 700 of a third type of loss function 702 considered herein, in accordance with some embodiments. The loss function 702 is denoted herein as a “Type C” loss function. As shown, the loss function 702 is characterized by regions 704 having a negative second derivative, and a minima region 706 which is modeled by a smooth transition 708 (e.g., a parabolic function). A region of the smooth transition 710 is characterized by a positive second derivative.

FIG. 7B shows a simplified plot 720 of a first derivative 722 of the loss function 702. As shown, the first derivative 722 is characterized by regions 724a-b which are always decreasing, and continuously increasing region 726 (e.g., a straight line) corresponding to the minima region 706.

Thus, a loss function is denoted herein as a Type B loss function if the small region surrounding the minimum is modeled as a piecewise linear function, or as a Type C loss function if this small region is continuous, e.g., parabolic. In both Type B and Type C loss functions, the abrupt vertical change of the derivative associated with the Type A loss function is replaced by a “smoother” or less vertical change in the small region surrounding the minimum.

For convenience, if any of the loss functions (Type A, Type B, or Type C) have a non-zero location parameter m_{q} [symbol] m_{q(i)}, i.e., L_{q}(rᵢ) is the minimum for a residual r=m_{q}, the loss function L_{q}(rᵢ) may be redefined as,

$${L}_{q} ( {r}_{i} - {m}_{q} ) \qquad ( Equation 11 )$$

such that the location parameter may be eliminated, and each loss function L_{q} shows a minimum at r=0. That is, each of the loss functions may be shifted such that the respective minimum occurs at r=0.

Likewise, each loss function L_{q}(rᵢ) may be shifted up or down, and scaled, (i.e., using β_{q}, α as discussed above) such that its minimum or maximum is set to a desired level. While fitting the modeled loss function to the corresponding PDF or CDF, the location parameter cannot be removed and the shift/scale cannot be applied. However, these parameters can be removed or applied while solving for min ΣL_{q}(rᵢ).

As shown in FIG. 5B, FIG. 6B, and FIG. 7B, the first derivative of the loss function L_{q}(rᵢ), i.e.,

$${ϕ}_{q} ( {r}_{i} ) = \frac{d {L}_{q} ( {r}_{i} )}{dr} , \qquad ( Equation 12 )$$

is strictly negative before m_{q} and strictly positive after m_{q}. Thus, the minimization includes finding the roots of the derivative,

$$ϕ ( r ) {=}^{△} \sum {ϕ}_{q} ( {r}_{i} ) = 0 , \qquad ( Equation 13 )$$

when the derivatives exist, or a solution where the derivative ϕ(r⁻)≤0 and ϕ(r⁺)≥0, where r⁻, r⁺ surround a singularity of some ϕ_{q}, i.e., slightly before or slightly after.

### Loss Function Fitting

As discussed above with reference to step 202 of the process 200, positioning, navigation and/or timing data for multiple regions is collected by one or more servers (e.g., using signal monitoring units, crowdsourced data, surveyed data, etc.). Using the data collected for a region, the server may calculate a CDF of residuals associated with that region and/or one or more signal quality metrics, preferably per bin of one or more criteria such as signal strength, path quality, relative paths, power, etc. The server may generate a multidimensional table of bins if each bin is sufficiently populated to obtain a relatively clean CDF. This step requires, at least preferably, knowledge of ground and timing truth for computing devices and/or signal monitoring units within the region to compute the true residuals.

It is possible afterward to smooth the CDF across bins. It can be helpful to average a large set of measurements to obtain a clean and consistent representation of the CDFs, e.g., the number of outliers cannot increase if the signal strength or quality increases (unless there is a bug or a fundamental issue).

The CDF helps determine the type or shape of loss functions to be used given that it is an objective disclosed herein to approximate (i.e., model) the loss function,

$${L}_{q} ( {r}_{i} ) \approx - log \frac{d {C}_{q} ( {r}_{i} )}{{dr}_{i}} , \qquad ( Equation 14 )$$

### or the CDF,

$${C}_{q} ( {r}_{i} ) \approx {\int }_{- ∞}^{{r}_{i}} exp ( - {L}_{q} ( r ) ) dr . \qquad ( Equation 15 )$$

With reference to step 204 of the process 200, the server may optionally directly fit the loss function using these formulas by first differentiating the CDF and then applying a negative logarithm to obtain an approximate empirically derived loss function, then further adjusting the loss function, and then applying the exponential and integrating to validate how it fits the empirically derived CDF. Such fitting places constraints on the parameters α, β_{q}, and m_{q}. As discussed above, m_{q} is the point where the PDF is maximum i.e., the point where the CDF changes from increasing slope to decreasing slope.

### Fitting a Loss Function to the CDF

To generate a model of a regionally specific loss function for a given measurement quality, a fitting model is first needed. In some embodiments, the server models the regionally specific loss function L_{q}(rᵢ) using a piecewise linear function, and its derivative ϕ_{q}(rᵢ) using a piecewise constant function (multi-step function). Using this approach, an efficient process to solve the multilateration problem is disclosed herein with reference to steps 208-214 of the process 200.

Each modeled loss function L_{q}(rᵢ) includes several sections or segments. The constant value of the derivative ϕ_{q}(rᵢ) in a segment j for anchor i is denoted herein by ϕ_{d,j}. The segment j of anchor i includes a segment of values rᵢ having derivative ϕ_{q}(rᵢ)=ϕ_{q,j}.

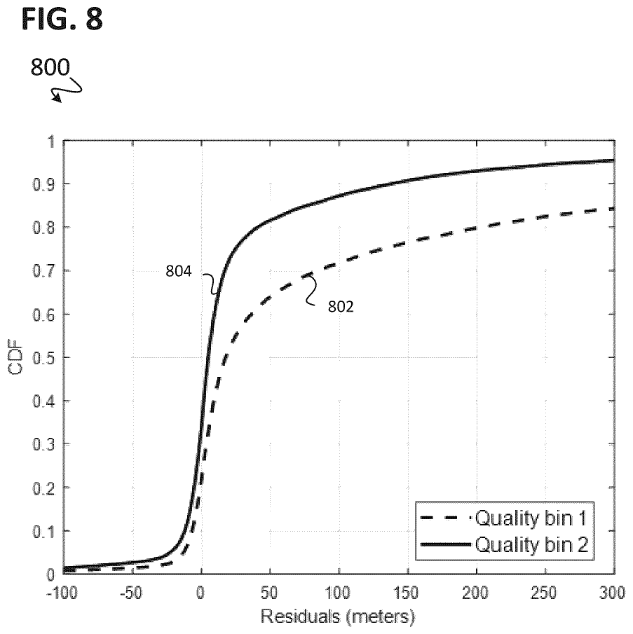

The CDF observed in typical non-line-of-sight (NLOS) radio signal propagation has a shape similar to that shown in FIG. 8, which shows a simplified plot 800 of two CDFs 802 and 804 of residuals, in accordance with some embodiments. The CDF 802 corresponds to a first residual quality bin (“Quality bin 1”), and the CDF 804 corresponds to a second residual quality bin (“Quality bin 2”). A corresponding empirically derived loss function may be obtained by the server for each of the CDFs 802 and 804 by first applying some amount of smoothing, and then differentiation.

One example of an empirically derived loss function is provided in FIG. 9A, which shows a simplified plot 900 of a loss function 902, in accordance with some embodiments. Regions of interest of the loss function 902 include outlier areas 904a-b, a roughly linear segment 906 on a negative side of the loss function 902 (i.e., to the left of the location parameter m_{q}), a first roughly linear segment 908 on a positive side of the loss function 902 (i.e., to the right of the location parameter m_{q}), and a second roughly linear segment 910 on the positive side of the loss function 902. Also shown is a segment reference point S_{q,j,0} of the segment 910 having length Δ_{q,j}, which is discussed in detail below.

As shown, the loss function 902 can be approximated (i.e., modeled) by the server using three piecewise-linear segments on each side of the location parameter m_{q}, i.e., the residual where the minimum of the function is observed (the location parameter m_{q} is almost zero in this case). For example, with reference to step 304 of FIG. 3, the residuals shown in FIG. 9A may be initially split into a first set of residuals (e.g., corresponding to the outlier area 904a) for residual values −600 m to about −200 m, a second set of residuals of about −200 m to −50 m, a third set of residual values of about −50 m to about 0 m (e.g., corresponding to the roughly linear segment 906), a fourth set of residual values of about 0 m to 50 m (e.g., corresponding to the roughly linear segment 908), a fifth set of residual values of about 50 m to about 1550 m (e.g., corresponding to the second roughly linear segment 910), and a sixth set of residual values of about 1550 m to 2000 m (e.g., corresponding to the outlier area 904b).

An enlarged view 920 of a small region of the loss function 902 surrounding the location parameter m_{q} is shown in FIG. 9B, in accordance with some embodiments. The small region surrounding the location parameter m_{q} is, for example, less than 20 meters on each side and may have a somewhat quadratic shape (between −20 and +20 meters around the location parameter). In some embodiments, the region surrounding the location parameter is modeled as a piecewise-linear function for simplicity.

Fitting six piecewise-linear segments to the loss function 902, i.e., three on each side of the location parameter m_{q}, requires finding the segment edges. Once a segment edge is determined, a first-order polynomial fit may be used. Hence, there are, in this example, four or five parameters to estimate. The parameters to be estimated include two segment edges on each side, and possibly the position of the location parameter m_{q}, although the location parameter m_{q} is usually roughly known.

Starting from an initial guess on the four section edge parameters, the server may perform the following optimization procedure described below to improve the fit of the modeled loss function to the empirically derived loss function that is based on the CDF for a give region, with the unknowns being the location of the section edges.

As a first option, the server may minimize the overall fit of the segments in the loss function domain. The server may place more importance on the inner segments than the outer segments (outlier segments). The server may additionally account for the density of points in a given segment when measuring the fit.

As a second option, the server may obtain a CDF based on the loss function using the expression,

$${C}_{q}^{f} ( {r}_{i} ) = {\int }_{- ∞}^{{r}_{i}} exp ( - {L}_{q} ( r ) ) dr , \qquad ( Equation 16 )$$

and then fit the segments in the CDF domain. The server may apply appropriate weightings for different regions of segments (central region versus tails). This process determines L_{q}(rᵢ) assuming a piecewise-linear approximation.

### Maximum Likelihood (ML) Fitting of the Loss Functions

In some embodiments, the server may fit the loss functions using an ML criterion instead of fitting to the CDF (where the CDF can still be used for validation, and possibly for the initial guess on the loss function). In this scenario, the same experimental residuals from a large number of measurements may be used as follows:

$${min}_{{L}_{q}} {\sum }_{i} {L}_{q} ( {r}_{i} ) , \qquad ( Equation 17 )$$

where index i denotes residuals from all measurements having quality q in the training data. It is assumed that the server approximately knows, based on data collected for a given region, the ground and time truth for the region in order to properly estimate the residuals.

Since each loss function L_{q} of index q is independent of the other loss functions, the above double summation may be separated into a single minimization routine and a single summation per loss function L_{q}. In other words, all observations/residuals of given quality or features may be grouped by the server to use the same loss function and the server may optimize this loss function. The server may then repeat the same operation for other groups of observations (or loss functions) independently. Once a modeled loss function is generated, the server may validate it by comparing the loss function with the corresponding empirically derived CDF.

To elaborate, the ML may be expressed as

$${max}_{{P}_{q}} {\prod }_{i} {P}_{q} ( {r}_{i} ) , \\ subject to \qquad ( Equation 18 )$$

$${\int }_{- ∞}^{+ ∞} {P}_{q} ( r ) dr = 1 , \\ and \qquad ( Equation 19 )$$

$${P}_{q} ( r ) \geq 0. \qquad ( Equation 20 )$$

Based on the above, for the loss function,

$${L}_{q} ( r ) = - log {P}_{q} ( r ) , \qquad ( Equation 21 )$$

the following expression may be derived,

$${min}_{{L}_{q}} {\sum }_{i} {L}_{q} ( {r}_{i} ) , \qquad ( Equation 22 )$$

which is subject to the constraint that the area below the probability density function is equal to 1, i.e.,

$${\int }_{- ∞}^{+ ∞} {e}^{- {L}_{q} ( r )} dr = 1. \qquad ( Equation 23 )$$

In the domain of the loss function, the constraint P_{q}(r)≥0 is always satisfied for P_{q}(r)=e^{-L}^{_{q}}^{(r)}.

### Loss Function Modeled as a Piecewise Polynomial Function

Disclosed herein is a process to model or approximate an empirically derived loss function by breaking the loss function into a number of pieces or segments S_{q,j}, each of length Δ_{q,j}, having a respective starting point S_{q,j,start}, and end point S_{q,j, end} (such that S_{q,j,end}−S_{q,j,start}=Δ_{q,j}), and having a reference point S_{q,j,0} that can be any reference point for the segment, e.g., the starting point, the end point, a mid-point, or even a point outside the segment.

In some embodiments, the reference point S_{q,j,0} is selected as the point where the lowest order polynomial function can be best fitted, e.g., toward the middle of the segment. For a piecewise constant or linear fit, the reference point is not as important, i.e., the starting point of the segment is usually selected as the reference point unless the starting point is −∞, in which case the end point may be selected as the reference point. Nevertheless, for fixed point arithmetic, it is beneficial to select the middle of the segment as a reference point. Normally, the segments are contiguous.

In some embodiments, it is assumed that the segmentation S_{q,j} is fixed. Within each segment, the loss function is approximated by a polynomial function (or Taylor series) of some order η_{q,j}, around a reference point S_{q,j,0}, i.e.,

$${L}_{q} ( {r}_{i} ∈ {S}_{q , j} ) = {L}_{q , j}^{( 0 )} + ( {r}_{i} - {S}_{q , j , 0} ) {L}_{q , j}^{( 1 )} + {( {r}_{i} - {S}_{q , j , 0} )}^{2} {L}_{q , j}^{( 2 )} + … = {\sum }_{n = 0}^{{η}_{q , j}} {( {r}_{i} - {S}_{q , j , 0} )}^{n} {L}_{q , j}^{( n )} . \qquad ( Equation 24 )$$

The polynomial coefficients L_{q,j}⁽ⁿ⁾ are to be determined based on the ML fit. For convenience, the shorthand L_{q,j} [symbol] L_{q,j}⁽⁰⁾ is defined. Additionally, the partial nth order sample moments are defined as,

$${\overline{r}}_{q , j}^{( n )} = \frac{1}{{N}_{q}} {\sum }_{i} {( {r}_{i} - {S}_{q , j , 0} )}^{n} , \qquad ( Equation 25 )$$

which is normalized by the total number of samples N_{q} and referenced to the segment-specific reference point S_{q,j,0}. The total cost of the training residuals per segment is therefore

$${\sum }_{i} {L}_{q} ( {r}_{i} ∈ {S}_{q , j} ) = {N}_{q} ( {\overline{r}}_{q , j}^{( 0 )} {L}_{q , j}^{( 0 )} + {\overline{r}}_{q , j}^{( 1 )} {L}_{q , j}^{( 1 )} + {\overline{r}}_{q , j}^{( 2 )} {L}_{q , j}^{( 2 )} + … ) = {N}_{q} {\sum }_{n} {\overline{r}}_{q , j}^{( n )} {L}_{q , j}^{( n )} , \qquad ( Equation 26 )$$

$$where$$

$${\overline{r}}_{q , j}^{( 0 )} = \frac{{N}_{q , j}}{{N}_{q}} , \qquad ( Equation 27 )$$

$$and$$

$${\sum }_{j} {\overline{r}}_{q , j}^{( 0 )} = 1. \qquad ( Equation 28 )$$

The polynomial coefficients L_{q,j}⁽ⁿ⁾ are determined by the server by minimizing the total cost for the training residuals, subject to a constraint that the area under the PDF corresponding to the loss function has to be 1 (e.g., as shown in Equation 19).

The area for the segment S_{q,j}, with integration variable r referenced to S_{q,j,0}, is determined by,

$$\begin{matrix}{A}_{q , j} = {\int }_{{S}_{q , j}} {P}_{q , j} ( r ) dr \\ = {\int }_{{S}_{q , j}} {e}^{- {L}_{q , j}^{( 0 )} - {L}_{q , j}^{( 1 )} r - {L}_{q , j}^{( 2 )} {r}^{2} - …} dr \\ = {\int }_{{S}_{q , j , start} - {S}_{q , j , 0}}^{{S}_{q , j , end} - {S}_{q , j , 0}} {e}^{- {\sum }_{n} {L}_{q , j}^{( n )} {r}^{n}}\end{matrix} . \qquad ( Equation 29 )$$

As shown in the preceding equation, the loss function has been converted into a corresponding PDF, denoted by,

$${P}_{q , j} ( r ) = {e}^{- {Σ}_{n} {L}_{q , j}^{( n )} {r}^{n}} , \qquad ( Equation 30 )$$

and the inside segment S_{q,j} has been integrated.

Let A_{q,j}⁽⁰⁾ [symbol] A_{q,j}e^{L}^{_{q,j}}, which is the area if L_{q,j}=0. Subsequently, the problem may be solved by using the Lagrange multipliers. For the loss function, the partial derivative with respect to the nth coefficient is

$$\frac{\partial {\sum }_{i} {L}_{q} ( {r}_{i} ∈ {S}_{q , j} )}{\partial {L}_{q , j}^{( n )}} = {N}_{q} {\overline{r}}_{q , j}^{( n )} , \qquad ( Equation 31 )$$

and the partial derivative of the constraint area under the PDF is,

$$\frac{\partial {A}_{q , j}}{\partial {L}_{q , j}^{( n )}} = - {\int }_{{S}_{q , j}} {r}^{n} {P}_{q , j} ( r ) dr {=}^{△} - {M}_{q , j}^{( n )} , \qquad ( Equation 32 )$$

where M_{q,j}⁽ⁿ⁾ is the nth moment of the modeled distribution. For the 0^{th} moment, M_{q,j}⁽⁰⁾=A_{q,j}, and

$${\sum }_{j} {M}_{q , j}^{( 0 )} = {\sum }_{j} {A}_{q , j} = 1. \qquad ( Equation 33 )$$

In order to simplify the integration, it can be sometimes advantageous to integrate the area before differentiating to find a given moment.

Denoting the Lagrange multiplier by λ, at an extremum the gradients of the loss function and the constraint are colinear, i.e.,

$${N}_{q} {\overline{r}}_{q , j}^{( n )} = λ {M}_{q , j}^{( n )} . \qquad ( Equation 34 )$$

For the 0^{th} moment, the expression,

$${N}_{q , j} = λ {M}_{q , j}^{( 0 )} = λ {A}_{q , j} , \qquad ( Equation 35 )$$

may be obtained. By summing over all segments, N_{q}=λ may be obtained. Therefore,

$${M}_{q , j}^{( n )} = {\overline{r}}_{q , j}^{( n )} . \qquad ( Equation 36 )$$

This result means that per segment, the n^{th} moment of the fitted PDF is equal to the n^{th}sample-moment of the training residuals. The moment M_{q,j}⁽ⁿ⁾ is a function of the coefficients L_{q,j}, L_{q,j}⁽¹⁾, L_{q,j}⁽²⁾. . . , which leads to a system of equations to be solved, usually numerically, to find the coefficients. Additionally, the solution must be validated to determine that it is a global minimum.

For the 0^{th} moment, the following may be found:

$${M}_{q , j}^{( 0 )} = {A}_{q , j} = {A}_{q , j}^{( 0 )} {e}^{- {L}_{q , j}} = {\overline{r}}_{q , j}^{( 0 )} = \frac{{N}_{q , j}}{{N}_{q}} , \qquad ( Equation 37 )$$

i.e.,

$${L}_{q , j} = - log \frac{{N}_{q , j}}{{N}_{q} {A}_{q , j}^{( 0 )}} . \qquad ( Equation 38 )$$

However, the area A_{q,j}⁽⁰⁾ depends on the coefficients L_{q,j}⁽¹⁾, L_{q,j}⁽²⁾ which are not yet determined. Furthermore, for a given segment, the area under the PDF at the optimum solution is fixed and equal to,

$${A}_{q , j} = \frac{{N}_{q , j}}{{N}_{q}} . \qquad ( Equation 39 )$$

This result can be advantageously generalized to any loss function L_{q}(rᵢ) of any differentiable shape, not just for piecewise polynomial shapes, that incorporates an unknown translation, L_{q,j}, within a segment S_{q,j} of length Δ_{q,j}. For example, L_{q}(rᵢ)=L_{q,j}+L̅_{q,j}(rᵢ). The Lagrange multiplier for the 0^{th} moment leads to the usual result:

$$λ = {N}_{q} , \qquad ( Equation 40 )$$

$${A}_{q , j} = \frac{{N}_{q , j}}{{N}_{q}} , and \qquad ( Equation 41 )$$

$${L}_{q , j} = - log \frac{{N}_{q , j}}{{N}_{q} {A}_{q , j}^{( 0 )}} . \qquad ( Equation 42 )$$

Given that the optimal area under the PDF for a given segment is known and equal to

$${A}_{q , j} = \frac{{N}_{q , j}}{{N}_{q}} , \qquad ( Equation 43 )$$

this advantageously leads to an optimization for each segment independently of other segments, the constraint being that the area under the PDF for the given segment is the constant

$$\frac{{N}_{q , j}}{{N}_{q}} ,$$

assuming fixed segmentation. Furthermore, this result simplifies the overall optimization since the intersection may be shifted between two adjacent segments without impacting the solution for the other segments: only the two adjacent segments are impacted.

### Loss Function Modeled as Piecewise Constant Function

A multi-step function or piecewise constant function means only the parameter L_{q,j} is non-zero per segment. The optimal area per segment is

$${A}_{q , j}^{( 0 )} {e}^{- {L}_{q , j}} = {A}_{q , j} = \frac{{N}_{q , j}}{{N}_{q}} = {Δ}_{q , j} {e}^{- {L}_{q , j}} . \qquad ( Equation 44 )$$

### Therefore,

$${L}_{q , j} = - log \frac{{N}_{q , j}}{{N}_{q} {Δ}_{q , j}} \qquad ( Equation 45 )$$

The corresponding multi-step PDF, e^{-L}^{_{q,j}}, is simply the proportion of points within the segment, normalized by the segment length. If the segment length Δ_{q,j}→∞, then L_{q,j}→0. As the solution is unique, then it must be the global minimum of the total cost. It cannot be a global maximum because a maximum cost of +∞ may be reached (i.e., choose one segment and set its PDF to 0, while maintaining the total area for all segments under PDF to 1. Then the loss function includes −log(0), which is +∞).

### Loss Function Modeled as Non-Continuous Piecewise Linear Function

In some embodiments, the loss function is modeled as a non-continuous piecewise linear function, where each segment is independent of the others and the area per segment should be

$$\frac{{N}_{q , j}}{{N}_{q}} .$$

The only non-zero coefficients are L_{q,j} and L_{q,j}⁽¹⁾. The shorthand

$${L}_{q , j}^{′} = Δ {L}_{q , j}^{( 1 )} , \\ and \qquad ( Equation 46 )$$

$${\overline{r}}_{q , j} {=}^{△} \frac{{N}_{q}}{{N}_{q , j}} {\overline{r}}_{q , j}^{( 1 )} = \frac{1}{{N}_{q , j}} {\sum }_{i} ( {r}_{i} - {S}_{q , j , 0} ) = - {S}_{q , j , 0} + \frac{1}{{N}_{q , j}} {\sum }_{i} {r}_{i} , \qquad ( Equation 47 )$$

may be defined for the first sample moment or average within the segment. In some scenarios, it may be advantageous to change the reference point of a segment such that,

$${L}_{q , j , new} + ( {r}_{i} - {S}_{q , j , new} ) {L}_{q , j}^{′} = {L}_{q , j , old} + ( {r}_{i} - {S}_{q , j , 0} ) {L}_{q , j}^{′} , \qquad ( Equation 48 )$$

where S_{q,j,new} is the new desired reference point, and L_{q,j,new} is the updated offset. L_{q,j,old} is the previous offset, and the slope L′_{q,j} is unchanged. Therefore,

$${L}_{q , j , new} = {L}_{q , j , old} + ( {S}_{q , j , new} - {S}_{q , j , 0} ) {L}_{q , j}^{′} , \qquad ( Equation 49 )$$

and if the reference is changed from the start of the segment to the end of the segment, then

$${L}_{q , j , end} = {L}_{q , j , start} + {Δ}_{q , j} {L}_{q , j}^{′} . \qquad ( Equation 50 )$$

If the segment S_{q,j,0} is selected to be the start of the segment (for an end of segment reference, replace L_{q,j} by L_{q,j,end}−Δ_{q,j}L′_{q,j}), then the area under the PDF for the segment is,

$${A}_{q , j} = {\int }_{0}^{{Δ}_{q , j}} {e}^{- {L}_{q , j} - {L}_{q , j}^{′} r} dr = \frac{1 - {e}^{- {L}_{q , j}^{′} {Δ}_{q , j}}}{{L}_{q , j}^{′}} {e}^{- {L}_{q , j}} = \frac{{N}_{q , j}}{{N}_{q}} . \qquad ( Equation 51 )$$

For the end of segment reference, the offset L_{q,j,start} changes to L_{q,j,end}. For example, if the area under the PDF for a segment is expressed as

$$\frac{{e}^{{L}_{q , j}^{′} {Δ}_{q , j}} - 1}{{L}_{q , j}^{′}} {e}^{- {L}_{q , j , end}}$$

and the difference in loss value between the two edges of the segment (negative if the slope is negative) is expressed as L′_{q,j}Δ_{q,j}=L_{q,j,end}−L_{q,j,start}, then the area can also be expressed as,

$${A}_{q , j =} \frac{{e}^{- {L}_{q , j , start}} - {e}^{- {L}_{q , j , end}}}{{L}_{q , j , end} - {L}_{q , j , start}} {Δ}_{q , j} . \qquad ( Equation 52 )$$

For L′_{q,j}→0, the same constraint is found as for the multi-step function, i.e.,

$${Δ}_{q , j} {e}^{- {L}_{q , j}} = \frac{{N}_{q , j}}{{N}_{q}} . \qquad ( Equation 53 )$$

The area is then

$${A}_{q , j}^{( 0 )} {=}^{△} \frac{1 - {e}^{- {L}_{q , j}^{′} {Δ}_{q , j}}}{{L}_{q , j}^{′}} . \qquad ( Equation 54 )$$

It is easy to validate that A_{q,j}⁽⁰⁾>0 (i.e., validate it separately for L′_{q,j}>0 and for L′_{q,j}<0, and note that for L′_{q,j}→0, the area A_{q,j}⁽⁰⁾→Δ_{q,j}). For the 0^{th} moment, the coefficients may be expressed as

$${L}_{q , j} = - log \frac{{N}_{q , j}}{{N}_{q} {A}_{q , j}^{( 0 )}} . \qquad ( Equation 55 )$$

For the first moment, the negative of the derivative of the area with respect to L′_{q,j} is equal to the partial first-order sample moment, i.e.,

$$- \frac{{e}^{- {L}_{q , j}^{′} {Δ}_{q , j}} ( {L}_{q , j}^{′} {Δ}_{q , j} + 1 ) - 1}{{L}_{q , j}^{′2}} \frac{{N}_{q , j}}{{N}_{q} {A}_{q , j}^{( 0 )}} = {\overline{r}}_{q , j}^{( 0 )} = \frac{{N}_{q , j}}{{N}_{q}} {\overline{r}}_{q , j} . \qquad ( Equation 56 )$$

i.e.,

$${\overline{r}}_{q , j} + \frac{{e}^{- {L}_{q , j}^{′} {Δ}_{q , j}} ( {L}_{q , j}^{′} {Δ}_{q , j} + 1 ) - 1}{{L}_{q , j}^{′} ( 1 - {e}^{- {L}_{q , j}^{′} {Δ}_{q , j}} )} = 0 , \qquad ( Equation 57 )$$

i.e.,

$$( {\overline{r}}_{q , j} {L}_{q , j}^{′} - 1 ) + ( ( {Δ}_{q , j} - {\overline{r}}_{q , j} ) {L}_{q , j}^{′} + 1 ) {e}^{- {L}_{q , j}^{′} {Δ}_{q , j}} = 0. \qquad ( Equation 58 )$$

For the case of Δ_{q,j}→∞, the second term fades, and the solution is

$${L}_{q , j}^{′} \to \frac{1}{{\overline{r}}_{q , j}} .$$

Otherwise, the function may be normalized as follows: let

$${L}_{q , j}^{′Δ} \hat{=} {L}_{q , j}^{′} {Δ}_{q , j} and {\overline{r}}_{q , j}^{Δ} \hat{=} \frac{{\overline{r}}_{q , j}}{{Δ}_{q , j}} .$$

It is easy to show that 0≤r̅_{q,j}^{Δ}<1 if the reference point S_{q,j,0} is the start of the segment. Then,

$$( {\overline{r}}_{q , j}^{Δ} {L}_{q , j}^{′Δ} - 1 ) + ( ( 1 - {\overline{r}}_{q , j}^{Δ} ) {L}_{q , j}^{′Δ} + 1 ) {e}^{- {L}_{q , j}^{′ Δ}} = 0. \qquad ( Equation 59 )$$

The equation above has a first solution for L′_{q,j}^{Δ}=0 that corresponds to the multi-step function. This solution may be ignored, except for r̅_{q,j}^{Δ}=0.5, corresponding to a flat region.

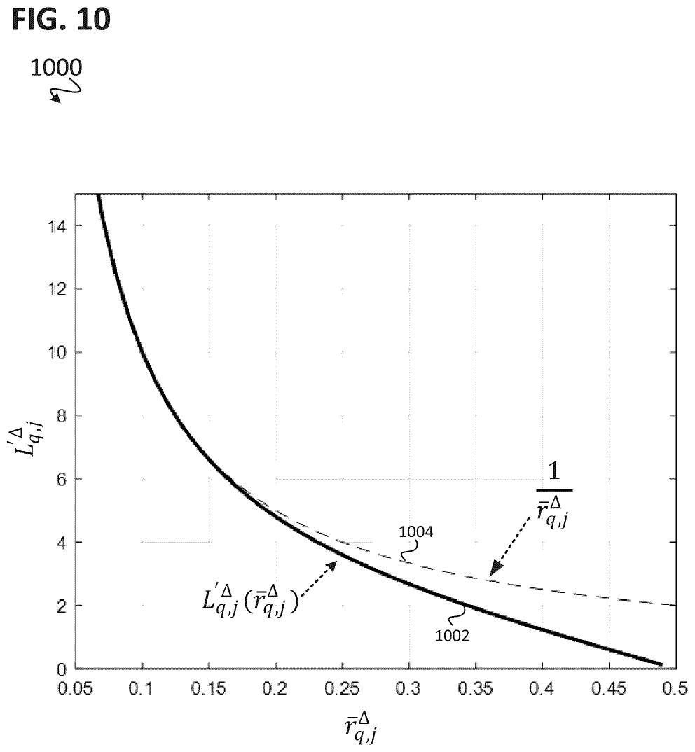

FIG. 10 shows a simplified graph 1000 of unique solution plots 1002 and 1004 for equation 59, in accordance with some embodiments. The plots 1002 and 1004 are shown for each 0<r̅_{q,j}^{Δ}<0.5 for the function L′_{q,j}^{Δ}(r̅_{q,j}^{Δ}). The solution plot 1002 is the exact solution for equation 59, which provides L′_{q,j}^{Δ} (normalized slope) as a function of r̅_{q,j}^{Δ} (normalized sample mean). The solution plot 1004 is an approximate solution to equation 59 when r̅_{q,j}^{Δ} is sufficiently small (e.g., the normalized sample mean is less than around 0.1). The solutions shown exhibit the following odd symmetry relative to r̅_{q,j}^{Δ}=0.5: by replacing r̅_{q,j}^{Δ} by 1−r̅_{q,j}^{Δ} and L′_{q,j}^{Δ} by −L′_{q,j}^{Δ} leads to a symmetrical solution. This is an expected result as the slope should be the opposite when the normalized mean is on the other symmetrical side within the segment. Therefore, it is sufficient to consider the interval 0≤r̅_{q,j}^{Δ}<0.5 with positive L′_{q,j}^{Δ}. The interval 1>r̅_{q,j}^{Δ}>0.5 is automatically obtained via odd symmetry around r̅_{q,j}^{Δ}=0.5 (symmetry around vertical axis r̅_{q,j}^{Δ}=0.5 followed by symmetry around the horizontal axis L′_{q,j}^{Δ=0}).

To elaborate, in some embodiments, optimization is performed as follows. First, a reference point of a segment is assumed. If the start of the segment is −∞, then the end of the segment is used as a reference point. Next, a partial sample moment r̅_{q,j} is obtained and normalized by the segment length Δ_{q,j} to obtain r̅_{q,j}^{Δ}. If r̅_{q,j}^{Δ} is greater than 0.5, the position of the segment reference point is changed to the end of the segment. To reflect the change in the reference point, r̅_{q,j}^{Δ} is replaced by 1−r̅_{q,j}^{Δ} and r̅_{q,j} by Δ_{q,j}−r̅_{q,j}. From the graph 1000, a corresponding L′_{q,j}^{Δ} may be obtained (based on the plot 1002), and it may be divided by Δ_{q,j} to obtain the slope L′_{q,j}. Next, the area A_{q,j}⁽⁰⁾ is computed and the offset L_{q,j} is determined. The current cost for the training data in that segment may then be calculated.

In summary, from r̅_{q,j}^{Δ}, L′_{q,j}^{Δ} is obtained by using the plots 1000, and then L′_{q,j}, A_{q,j}⁽⁰⁾ and L_{q,j} are obtained, and then the loss function for the segment L_{q}(rᵢ)=L_{q,j}+(rᵢ−S_{q,j,0})L′_{q,j} is obtained. The total cost for the training residuals in the segment S_{q,j} is ΣᵢL_{q}(rᵢ∈S_{q,j})=N_{q,j}(L_{q,j}+r̅_{q,j}L′_{q,j}).

Note that

$${L}_{q , j}^{′Δ} \approx \frac{1}{{\overline{r}}_{q , j}^{Δ}}$$

for a small r̅_{q,j}^{Δ}, as shown in FIG. 10, since for a large L′_{q,j}^{Δ}, the term e^{-L′}^{_{q,j}}^{Δ} vanishes. This includes the case where Δ_{q,j} has a large value. This results in

$${L}_{q , j}^{′} \approx \frac{1}{{\overline{r}}_{q , j}} , \qquad ( Equation 60 ) ,$$

$${A}_{q , j}^{( 0 )} \approx {\overline{r}}_{q , j} , \qquad ( Equation 61 )$$

$$and$$

$${L}_{q , j} \approx - log \frac{{N}_{q , j}}{{N}_{q} {\overline{r}}_{q , j}} . \qquad ( Equation 62 )$$

The coefficients of the loss functions don't depend on Δ_{q,j} as it becomes large. The advantage of using a piecewise linear loss function over a multi-step function is that it can better model the sharp drop near the minimum of the loss function, m_{q}, and it also has a PDF with an exponential form like a Laplace distribution, suitable for residuals with multipath errors (e.g., such as the loss function 900 shown in FIG. 9A).

However, as defined above, the piecewise linear loss function is not continuous per segment. It can be used as part of a first step to find an approximate loss function. The following step is to ensure continuity.

As a first simple example, let a large number of samples be drawn from a Laplace(0,1) distribution with 0 mean and diversity parameter b=1. A fit is then performed for the positive side segment starting from 0 and ending at +∞. Therefore,

$${S}_{q , j , 0} = 0 , \qquad ( Equation 63 ) ,$$

$${Δ}_{q , j} = + ∞ , \qquad ( Equation 64 ) ,$$

$$and$$

$${\overline{r}}_{q , j}^{Δ} = \frac{{\overline{r}}_{q , j}}{{Δ}_{q , j}} = \frac{1.}{{Δ}_{q , j}} . \qquad ( Equation 65 )$$

(the mean of the positive samples is 1.0).

Since r_{q,j}^{Δ}→0, the following may be expressed:

$${L}_{q , j}^{′} \to \frac{1}{{\overline{r}}_{q , j}} = 1 , \qquad ( Equation 66 )$$

$${A}_{q , j}^{( 0 )} \to {\overline{r}}_{q , j} = 1 , and \qquad ( Equation 67 )$$

$${L}_{q , j} \to - log \frac{{N}_{q , j}}{{N}_{q}} = - log \frac{1}{2} . \qquad ( Equation 68 )$$

Roughly half of the drawn samples will be on the positive side of the loss function, hence,

$${L}_{q} ( {r}_{i} > 0 ) = - log \frac{1}{2} + {r}_{i} . \qquad ( Equation 69 )$$

### The PDF is

$${e}^{- {L}_{q} ( {r}_{i} )} = \frac{1}{2} {e}^{- {r}_{i}} ,$$

for rᵢ>0, as expected for the Laplace distribution. The fit is perfect as the number of samples tends to infinity.

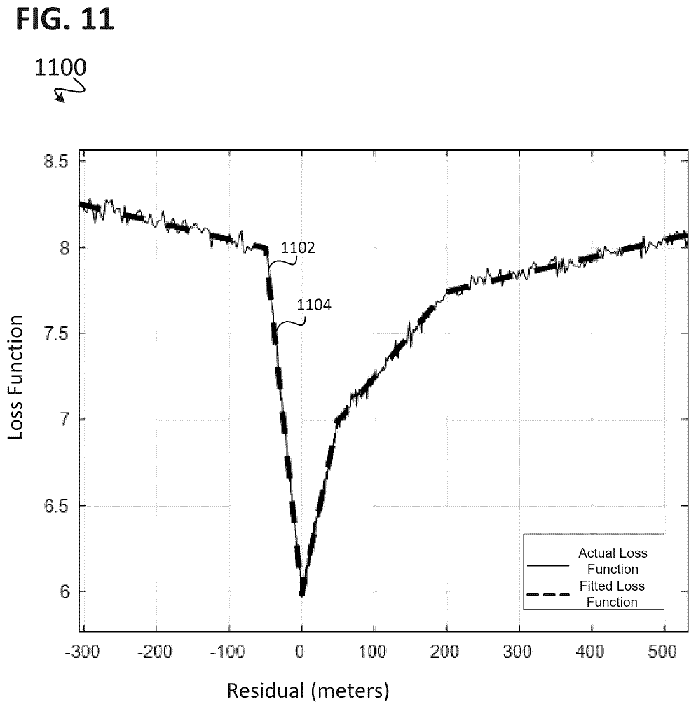

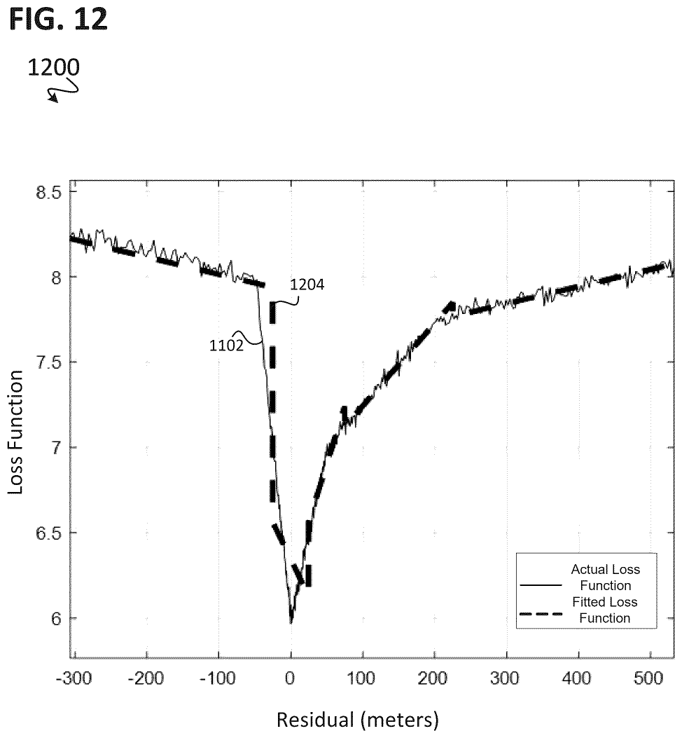

A second more elaborate example is illustrated in FIG. 11 and FIG. 12. FIG. 11 shows a plot 1100 of a simulated loss function 1102 (having a solid line) and a fit 1104 (having a dashed line) with perfect segmentation, in accordance with some embodiments. By comparison, FIG. 12 shows a plot 1200 of the simulated loss function 1102 (having a solid line) and a fit 1204 (having a dashed line) having imperfect segments, in accordance with some embodiments.

In the example shown, 1,000,000 simulated residuals following an ideal piecewise linear loss function are generated. FIG. 11 shows a fitted piecewise linear loss function 1104 (i.e., a modeled loss function) that assumes perfect knowledge of the segmentation (from the ideal version). The fit is near perfect. If only 10,000 points were used, the fit degrades a little (this is not shown in the figure). However, if the segment intersections have a small displacement, then the fit degrades as shown in the fitted loss function 1204 in FIG. 12.

As mentioned above, an important result is that for piecewise polynomial modeling of the loss function, the ML solution per segment is independent of other segments (assuming the segments' locations are fixed). This important result can be used to efficiently adjust the segment positions and lengths, varying one intersection at a time.

### Modeling Outer Segments with a Flat Loss Function

In cellular networks, for example, the outer segments on each side of an empirically derived loss function usually contain outlier residuals extending from +3 km to, approximately, +20 km (or + infinity) on the positive side, and likewise, e.g., from −0.5 km to, approximately, −20 km (or − infinity) on the negative side. Such values may correspond to a noise pulse appearing like a signal correlation peak, or an incorrect entry in the almanac of base stations leading to an outlier measurement. These outer segments should have a roughly flat loss function. However, the server may not have enough training residuals for the aforementioned process to correctly fit the loss function (or the outlier values may be concentrated in some sections of the segment due to various implementation issues).

In principle, with enough training residuals exhibiting a uniform distribution, it should be found for the outer segments that r̅_{q,j}^{Δ}≈0.5 and therefore the slope L′_{q,j}^{Δ}≈0. This is generally the correct fit even as the segment extends to infinity, i.e., Δ_{q,j}→∞. For such segments, the piecewise linear fit may be replaced by the piecewise constant fit. The segment L′_{q,j}=+ϵₚ may be forced on the positive side, and the segment L′_{q,j}=−ϵₙ may be forced on the negative side, where ϵₚ, ϵₙ are very small positive numbers modeling almost a flat loss function.

However, these segments should not be set to a slope of 0 to avoid convergence issues in the solver. The slopes are only used as the derivative of the loss function and are not used for calculating the loss function as the model may be replaced by a piecewise constant model. The value of,

$${L}_{q , j} = - log \frac{{N}_{q , j}}{{N}_{q} {Δ}_{q , j}} , \qquad ( Equation 70 )$$

is obtained as previously explained for the piecewise constant fit, or by forcing A_{q,j}⁽⁰⁾=Δ_{q,j}.

The length Δ_{q,j} is set to a reasonable finite value (typically when such outlier regions exist, the segments don't extend to infinity and are limited by the implementation; although an infinite value can be acceptable, leading to infinite loss function values and solver convergence issues). The start or end position of these two segments can be adapted to optimize the fit as discussed previously.

### Outer Segments Extending to Infinity with Exponential Fit

As disclosed herein, it is possible to use outer segments extending to infinity with the exponential fit or a piecewise linear loss function. The case of the positive side after the location parameter is considered below, using the start of the segment as the reference point (the negative side is symmetrical by using the end of the segment as the reference point). A condition is that the expression

$${L}_{q , j} = - log \frac{{N}_{q , j}}{{N}_{q} {A}_{q , j}^{( 0 )}} , \qquad ( Equation 71 )$$

is finite despite Δ_{q,j}→∞. Assuming non-zero

$$\frac{{N}_{q , j}}{{N}_{q}}$$

the condition means A_{q,j}⁽⁰⁾≈r̅_{q,j} is finite, which is usually the case.

### Procedure to Determine a Segment Set for a Piecewise Linear Loss Function

In the description above, a fixed piecewise segmentation of the loss function was assumed. In this section, finding an acceptable set of segments S_{q,j} is disclosed.

Starting from an approximate set of segments that are roughly fit to the loss function derived from the empirical CDF (e.g., the loss function 902 shown in FIG. 9A), the segment beginning point S_{q,j,start} and corresponding length Δ_{q,j} are varied by shifting the intersection left or right by a small amount and repeating the process described above, regarding modeling a loss function as a non-continuous piecewise linear function, until the overall cost is minimized. The cost is now optimized over segment positions and lengths besides L_{q} i.e.,

$${min}_{{L}_{q} , {S}_{q , j , start} , {Δ}_{q , j}} {\sum }_{i} {L}_{q} ( {r}_{i} ) , \qquad ( Equation 72 )$$

subject to the area under PDF being equal to unity.

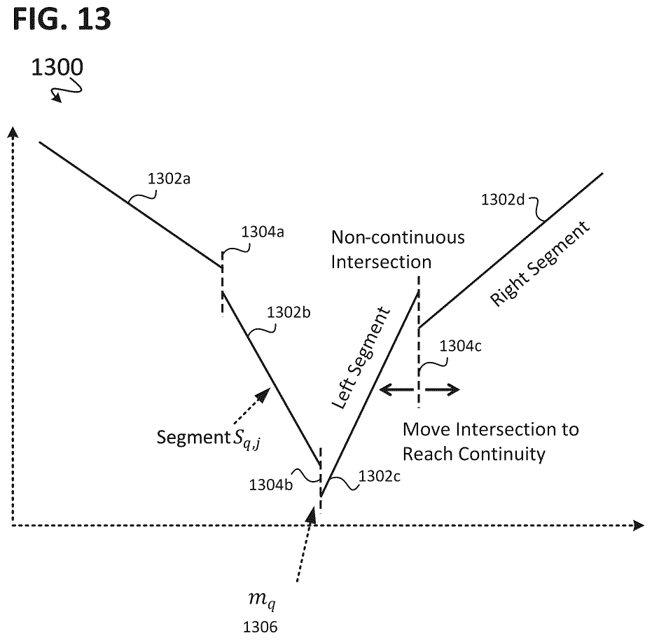

FIG. 13 shows a plot 1300 of a piecewise linear fit of the loss function 902 shown in FIG. 9A, in accordance with some embodiments. The piecewise linear fit includes segments 1302a-d and discontinuities 1304a-c. Also shown is the location parameter m_{q} 1306.

Generally, as described above with reference to independent optimization over segments, the fit is performed one intersection at a time. That is, advantageously, the optimization per segment does not depend on other segments (if the segments are fixed). Hence, the intersection between two adjacent segments may be adjusted without concern for the remaining segments: only the two adjacent segments are impacted by this change. The resultant area under the PDF will automatically have the value

$$\frac{{N}_{q , j}}{{N}_{q}}$$

for each segment.

Therefore the overall cost,

$${min}_{{L}_{q} , {S}_{q , j , start} , {Δ}_{q , j}} {\sum }_{i} {L}_{q} ( {r}_{i} ) , \qquad ( Equation 73 )$$

may be advantageously updated simply by updating the change of cost for the two adjacent segments, e.g., segments j−1 and j (e.g., with reference to FIG. 13, segments 1302c and 1302d). For one intersection between segments j−1 and j, the two adjacent segments have the following 3 unknowns to be adjusted:

$${S}_{q , j , start} , \qquad ( Equation 74 )$$

$${Δ}_{q , j - 1} = {S}_{q , j , start} - {S}_{q , j - 1 , start} , \qquad ( Equation 75 )$$

$$and$$

$${Δ}_{q , j} = {S}_{q , j + 1 , start} - {S}_{q , j , start} , \qquad ( Equation 76 )$$

while S_{q,j-1,start} and S_{q,j+1,start} are assumed to be unchanged. Adjusting the unknowns requires only adjusting one variable, S_{q,j,start}, as the other two variables are automatically obtained from S_{q,j,start}.

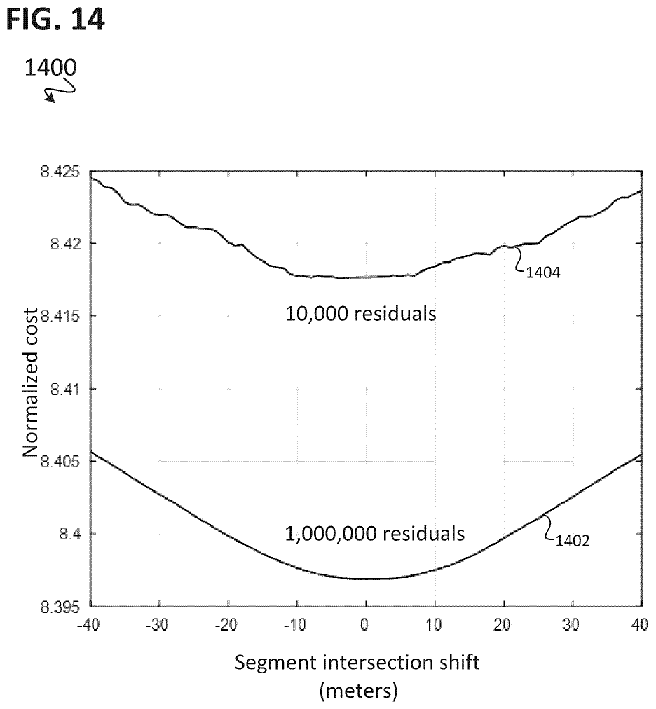

FIG. 14 shows a plot 1400 of cost values 1402 and 1404, in accordance with some embodiments. With reference to FIG. 11 and FIG. 12, the plot 1400 illustrates how the cost or loss of the training data changes when shifting the intersection of the segment preceding the location parameter m_{q}. The plot 1402 of normalized cost as a function of segment intersection shift corresponds to the example fitted loss function 1104 shown in FIG. 11 that was based on 1,000,000 simulated residuals. In contrast, the plot 1404 of normalized cost as a function of segment intersection shift corresponds to an example fitted loss function (not shown) that was based on 10,000 simulated residuals.

If shifting an intersection to the right, for example, improves the cost, the server may optionally continue shifting the intersection to the right until a minimum is reached before proceeding to another intersection. The process may then be repeated for other intersections until an overall minimum is reached, and the server may reiterate over all segments. The minimum should be near the global minimum if the starting choice of the segments S_{q,j,start} is reasonably good (e.g., where each segment is roughly linear according to the loss function generated from the empirical CDF). This procedure fits the piecewise linear loss function and the segmentation choice without concern for continuity between the segments. The only dependency between segments is related to the PDF area being equal to 1.

This procedure may automatically (approximately) locate the location parameter m_{q} as shown in the plot 1300 of FIG. 13. With reference to FIG. 13, the location parameter m_{q} is at the intersection of the two piecewise linear segments 1302b and 1302c surrounding the minimum of the modeled loss function, and is therefore found by adjusting the start and end positions of the segments. It may be advantageous to start optimizing the segment intersection around the location parameter m_{q} before proceeding outwards with the next intersections (left and right). And then reiterate after all intersections are processed.

### Procedure to Maintain Adjacent Segment Continuities

Continuity constraints of the type

$${L}_{q , j} = {L}_{q , j - 1} + {L}_{q , j - 1}^{′} {Δ}_{q , j} \qquad ( Equation 77 )$$

may be added for the start of a segment reference. This ensures that the start of the segment S_{q,j} is continuous with the end of the segment S_{q,j-1}. Adding such constraints to the overall solution and using the method of Lagrange multipliers is substantially complex. If this type of constraint were applied for every pair of adjacent segments iteratively, it would be too restrictive.

Therefore, in some embodiments, a simple solution to achieve continuity is to find the intersection between the loss of functions of adjacent segments, and then shift the segment boundaries to locate them at the intersections. Some segments are therefore shortened while others are prolonged. After this operation, the loss function is continuous. The intersection between the loss functions of two adjacent segments is found for the same segment intersection r_{intersect} and for the same loss value, i.e.,

$$( Equation 78 )$$

$${L}_{q , j - 1} + ( {r}_{intersect} - {S}_{q , j - 1 , 0} ) {L}_{q , j - 1}^{′} = {L}_{q , j} + ( {r}_{intersect} - {S}_{q , j , 0} ) {L}_{q , j}^{′}$$

For all quantities being fixed and known, the segment intersection r_{intersect} may be expressed as,

$${r}_{intersect} = \frac{{L}_{q , j} - {L}_{q , j - 1} + {L}_{q , j - 1}^{′} {S}_{q , j - 1 , 0} - {L}_{q , j}^{′} {S}_{q , j , 0}}{{L}_{q , j - 1}^{′} - {L}_{q , j}^{′}} . \qquad ( Equation 79 )$$

Thereafter, the segment boundaries are shifted to r_{intersect} where continuity is guaranteed.

In other embodiments, a more involved solution includes first optimizing one intersection at a time, and then optimizing iteratively over all intersections, and then possibly repeating. This solution preferably starts from an intersection corresponding to the location parameter (the minimum of the loss function) and moves outwards.

For a given intersection, the two segments involved are, for example, S_{q,j-1} and S_{q,j}. The sum of their length should remain constant, Δ_{q,j-1}+Δ_{q,j}=Γ, during the optimization. For simpler notation, a fixed or variable value of the loss function at the outer left edge of the left segment is denoted by L_{left}. Similarly, a fixed or variable value of the loss function at the outer right edge of the right segment is denoted by L_{right}. To achieve continuity at the intersection, it may be expressed that L_{q,j-1}=L_{q,j}.

The delta in loss function between the intersection and the outer edges may therefore be found by,

$${L}_{q , j - 1}^{′} {Δ}_{q , j - 1} = {L}_{q , j} - {L}_{left} \qquad ( Equation 80 )$$

$${L}_{q , j}^{′} {Δ}_{q , j} = {L}_{right} - {L}_{q , j} . \qquad ( Equation 81 )$$

Furthermore, as described above, the optimization has to maintain as a constant the sum of the area under the PDF. By choosing the reference point of both segments to be the intersection point (i.e., the end of the left segment and the start of the right segment), the sum of the area under the PDF is

$$( Equation 82 )$$

$$\frac{{e}^{{L}_{q , j - 1}^{′} {Δ}_{q , j - 1}} - 1}{{L}_{q , j - 1}^{′}} {e}^{- {L}_{q , j}} + \frac{1 - {e}^{- {L}_{q , j}^{′} {Δ}_{q , j}}}{{L}_{q , j}^{′}} {e}^{- {L}_{q , j}} = \frac{{N}_{q , j - 1} + {N}_{q , j}}{{N}_{q}} ,$$

which translates to

$$( Equation 83 )$$

$$\frac{{e}^{- {L}_{left}} - {e}^{- {L}_{q , j}}}{{L}_{q , j} - {L}_{left}} ( Γ - {Δ}_{q , j} ) + \frac{{e}^{- {L}_{right}} - {e}^{- {L}_{q , j}}}{{L}_{q , j} - {L}_{right}} {Δ}_{q , j} = \frac{{N}_{q , j - 1} + {N}_{q , j}}{{N}_{q}} .$$

In the expression above, Δ_{q,j} is chosen as the unknown and Δ_{q,j-1} is replaced by Γ−Δ_{q,j}. For the outer intersections, either Δ_{q,j-1} or Δ_{q,j} may be of infinite length and the corresponding L_{left} or L_{right} is infinite. Instead, the slope L′_{q,j-1} or L′_{q,j} may be used as the unknown, with the corresponding area under the PDF being

$$\frac{- {e}^{- {L}_{q , j}}}{{L}_{q , j - 1}^{′}} or \frac{{e}^{- {L}_{q , j}}}{{L}_{q , j}^{′}} .$$

It may be observed that the constant area under the PDF constraint provides a simple formula for Δ_{q,j} as a function of L_{left}, L_{q,j}, and L_{right}. Depending on the iteration, either L_{left} or L_{right}, or both, can be fixed. This is useful after some iterations to avoid changing the continuity of a previously optimized intersection for continuity.

Additionally, the loss function is minimized for the training data over the two segments,

$${min}_{{L}_{q , j} , {Δ}_{q , j}} {N}_{q , j - 1} ( {L}_{q , j} + {\overline{r}}_{q , j - 1} {L}_{q , j - 1}^{′} ) + {N}_{q , j} ( {L}_{q , j} + {\overline{r}}_{q , j} {L}_{q , j}^{′} ) , \qquad ( Equation 85 )$$

$$i . e . ,$$

$$( Equation 85 )$$

$${min}_{{L}_{q , j} , {Δ}_{q , j}} {N}_{q , j - 1} ( {L}_{q , j} + {\overline{r}}_{q , j - 1} \frac{{L}_{q , j} - {L}_{left}}{Γ - {Δ}_{q , j}} ) + {N}_{q , j} ( {L}_{q , j} + {\overline{r}}_{q , j} \frac{{L}_{right} - {L}_{q , j}}{Γ - {Δ}_{q , j}} ) .$$

The counts N_{q,j-1}, N_{q,j} are updated when Δ_{q,j} changes. Likewise, the sample averages multiplied by the counts, N_{q,j}r̅_{q,j}=−N_{q,j}S_{q,j,0}+Σᵢrᵢ can be quickly updated when Δ_{q,j} is changed: for example, the samples that switch from one segment to another (due to changing of segment boundary) are accumulated, and the accumulation is added to one segment and subtracted from the other segment. The sliding reference point S_{q,j,0}, i.e., the intersection of the segments, is also quick to update in this formula. This is a one, two, or three-dimensional minimization as a function of the unknowns or fixed L_{left}, L_{q,j}, L_{right}, without any constraints (since the constraint helped in replacing Δ_{q,j} by a function of the unknowns). It has many small local minima due to the distribution of the training data samples rᵢ. Hence, a grid-type of search is useful.

Before this optimization is begun there are different values for L_{q,j-1} and L_{q,j}. A probable solution lies somewhere in-between these initial values, or at least in the vicinity. Therefore, one solution is to perform a grid search over the variable L_{q,j} between the two initial values.

For each L_{q,j}, a candidate Δ_{q,j} is obtained from the constraint, assuming fixed values of L_{left}, L_{right}, and finding the value of the loss function. The candidate L_{q,j} and corresponding Δ_{q,j} may be selected that minimize the loss function.

A finer grid may be used as the solution converges toward the minimum. For any of the intermediate or final values, the loss function is continuous at the intersection given how the problem is formulated. In some cases, the process may need to also move the values of L_{left}, L_{right} a little, possibly toward achieving continuity with adjacent segments. When the variable is L′_{q,j-1} or L′_{q,j} for the infinite-length segments, this additional variable may be varied minorly until a minimum of the loss function is reached.

The process above may be repeated for another intersection, and optionally reiterated over intersections that were previously visited. The next time that the same intersection is revisited, the starting values are already L_{q,j-1}=L_{q,j} since continuity was previously reached and potentially unaffected when visiting other intersections. A possible grid search in the vicinity of the previous solution may further improve the loss function.

### Initial Guess for Segmentation

The options for an initial guess on segmentation S_{q,j} include using the empirical CDF of the training residuals in order to roughly find an initial guess for the segmentation. The initial guess may also be formulated based on the specifics of the problem. For example, in cellular networks with pseudorange estimates having multipath and NLOS residuals, an approximate segmentation can be obtained heuristically: a flat outlier region starts roughly at around 1 km; a segment for small residuals that extends from 0 to one over the bandwidth on each side of 0; a segment for intermediate residuals that fills the gap, and so on.

As another optional procedure for formulating an initial segmentation guess, if there are a sufficient number of residuals, the modeled loss function may be split into a larger number of segments, each having the same number of points. For example, given 10 to 16 segments: after sorting the residuals into blocks in increasing order, each block may be assigned to a segment. When optimizing for the modeled loss function, if two segments exhibit a roughly similar slope L′_{q,j}, they can be joined together. On the other hand, if a segment exhibits a high loss (high cost), it can be split into two segments (e.g., each subsegment having an equal number of residuals). If two adjacent segments do not satisfy the rule for having a positive second derivative (e.g., on the positive side after the location parameter m_{q}, if the L′_{a,j}>L′_{a,j-1}), then the segments may also be joined together to ensure that the slope does not change in the wrong way (which creates an oscillating loss function and reduces robustness against outliers and is usually due to insufficient and noisy training residuals).

The aforementioned procedures may begin from the initial segmentation and optimize the position of segments.

### Multilateration Solver

With reference to FIG. 2, having fitted and stored the modeled loss functions at steps 202, 204, and 206, at step 214, retrieved loss function models are used by the computing device and/or server to perform multilateration to determine an estimated position of the computing device within a region.

First disclosed herein is a solution that applies to any Type A loss functions (e.g., as shown and described with reference to FIGS. 5A-B), having a negative second derivative except for an abrupt change at the location parameter m_{q}. Then, the solution is extended for loss functions of Type B (e.g., as shown and described with reference to FIGS. 6A-B), and Type C (e.g., as shown and described with reference to FIGS. 7A-B).

### Optimum Linear Translation for Type A Loss Functions

In some scenarios, a displacement β that is common to all residuals may need to be found to satisfy,

$${min}_{β} {\sum }_{i} {L}_{q} ( {r}_{i}^{o} - β ) , \qquad ( Equation 86 )$$

with rᵢ=rᵢ^{o}−β. That is, the goal is to determine a constant displacement to an initial guess rᵢ^{o} of the residuals in order to minimize the sum of the loss functions. This is the case, for example, when the mobile position is known or estimated, and the clock bias b is to be determined. This is also the case for determining one of the geographical coordinates, x, y, z, provided that the distance is linearized. The minimum may be found by using the derivatives with respect to the offset β, i.e., the server may find β such that

$${\sum }_{i} - {ϕ}_{q} ( {r}_{i}^{o} - β ) = 0. \qquad ( Equation 87 )$$

Note the sign inversion of the derivative due to the negative sign in front of β. Given the attributes of Type A loss functions (e.g., as shown in FIG. 5A-B), a minimum can only occur at the abrupt change of the derivative of one of the loss functions L_{q} (i.e., at the point m_{q}). Any other positions on the loss function can produce either a maximum or no extremum.

This condition is proven as follows. If Σᵢϕ_{q}(rᵢ)<0 then the sign can become positive at the abrupt position in the region of the location parameter m_{q}. At any other position, Σᵢϕ_{q}(rᵢ)<0 is only decreasing. When the derivative (e.g., as shown in FIG. 5B) crosses from the negative to the positive side, a minimum exists. At other positions, if it crosses from the positive to the negative side, a maximum exists which is not a point of interest.

It is possible to consider the non-continuous fast vertical transitions of ϕ_{q}(rᵢ) as continuous transitions with infinitesimally short spans. It is also possible to consider the integral of ϕ_{q}(rᵢ), i.e., L_{q}, and note that despite the discontinuities in ϕ_{q}(rᵢ), the integral accumulates only in one direction as long as the derivative does not change sign. For an extremum, ϕ_{q}(rᵢ) has to change sign such that the integral starts accumulating in the opposite direction.

Therefore, it is enough to look for a displacement β corresponding to the minimum of each loss function, i.e.,

$${r}_{{i}^{′}} = {m}_{{q}^{′}} = {r}_{{i}^{′}}^{o} - β , \qquad ( Equation 88 )$$

having one such value per loss function L_{q′}, with q′=q(i′). I.e., for each L_{q′},

$$β = {r}_{{i}^{′}}^{o} - {m}_{{q}^{′}} \qquad ( Equation 89 )$$

is evaluated, and the for all i′,

$${min}_{β} {\sum }_{i} {L}_{q} ( {r}_{i}^{o} - β ) = {min}_{{i}^{′}} {\sum }_{i} {L}_{q} ( {r}_{i}^{o} - {r}_{{i}^{′}}^{o} + {m}_{{q}^{′}} ) \qquad ( Equation 90 )$$

is computed. Values for the i′ and corresponding β=r_{i′}^{o}−m_{q′} are selected that provide the minimum of this sum.

An important remark is that for piecewise linear loss functions, i.e., a multi-step function derivative, it is usually more efficient to check for the presence of a minimum by computing,

$${\sum }_{i} - {ϕ}_{q} ( {r}_{i}^{o} - β ) = {\sum }_{i} - {ϕ}_{q} ( {r}_{i}^{o} - {r}_{{i}^{′}}^{o} + {m}_{{q}^{′}} ) , \qquad ( Equation 91 )$$

and then checking if this sum changes sign between β⁻ and β⁺, i.e., slightly before β and slightly after β (given that for the precise value of r_{i′}=m_{q′}=r_{i′}^{o}−β, the derivative of a multi-step function is not defined, e.g., as shown in FIG. 5B and FIG. 6B). There is no need for linear interpolation when computing the sum of multi-step functions, hence a gain in compute efficiency is realized.

If the derivative shows that the function crossed from positive to negative (due to the sign inversion) then a local minimum has been identified. For this i′,

$${\sum }_{i} {L}_{q} ( {r}_{i}^{o} - β ) = {\sum }_{i} {L}_{q} ( {r}_{i}^{o} - {r}_{{i}^{′}}^{o} + {m}_{{i}^{′}} ) , \qquad ( Equation 92 )$$

may be computed. Otherwise, there is no need to compute it as there is no local minimum. This improvement assumes that the loss functions are continuous. If the loss functions are not continuous,

$${\sum }_{i} {L}_{q} ( {r}_{i}^{o} - β ) = {\sum }_{i} {L}_{q} ( {r}_{i}^{o} - {r}_{{i}^{′}}^{o} + {m}_{{q}^{′}} ) , \qquad ( Equation 93 )$$

needs to be computed for each i′. However, this is not recommended for non-continuous loss functions as it can generate instability during solver convergence.

### Optimum Linear Translation for Type B or Type C Loss Functions

For Type B loss functions, the main difference as compared to Type A loss functions is that there are multiple points to check, not only at the location parameter m_{q}. Thus ΣᵢL_{q}(rᵢ^{o}−β) needs to be checked for each rᵢ where the second derivative is positive, i.e., at the intersections with the linear segments where the first derivative increases in a step. In the example of the Type B loss function 602 shown in FIG. 6A, and the derivative thereof shown in FIG. 6B, there are 3 points where the first derivative increases in a step: at the start of the region of the positive second derivative, at the bottom where the minimum location parameter m_{q} is located, and at the end of the region of the positive second derivative. This point is denoted as the “positive step derivative point”. Hence, in this example, three “positive step derivative points” are checked instead of only one at mⱼ. For each such point m_{q}^{p} (that usually includes m_{q}), β=r_{i′}⁰−m_{q}^{p} is computed. The expression ΣᵢLᵢ(rᵢ^{o}−β) is then evaluated at each point, and the value of β that minimizes the sum is selected.

For Type C loss functions, the solution is a little more involved. The minimum may occur anywhere within the region of the increasing first derivative. Hence, an additional search is needed, where β is varied within this region until the zero of the derivative Σᵢϕ_{q}(rᵢ^{o}−β) is found. Once the zero is obtained, the corresponding ΣᵢL_{q}(rᵢ^{o}−β) is found. This procedure is repeated for all the positive second derivative regions of the loss functions L_{q}, and the minimum of the sum is selected.

### Displacement with Scaling

The common displacement parameter can be determined with known scales, each per observation, and can be different per observation. The problem becomes,

$${min}_{β} {\sum }_{i} {L}_{q} ( {r}_{i}^{o} - {α}_{i} β ) . \qquad ( Equation 94 )$$

where a different but known scaling per observation is applied to β. In this case, the same solution as above applies, with the following change to the first derivative with respect to β,

$${\sum }_{i} - {α}_{i} {ϕ}_{q} ( {r}_{i}^{o} - {α}_{i} β ) = 0. \qquad ( Equation 95 )$$

The first derivative per observation is scaled by a respective different αᵢ (with sign inversion, i.e., if αᵢ>0, the first derivative is flipped as β increases). The search is again at the same positive step derivative points as previously discussed, e.g., at m_{q}, but with a different scaling of β, and a different scaling of the derivatives.

For instance, for a given L_{q′}, r_{i′}=m_{q′}=r_{i′}^{o}−α_{i′}β becomes

$$β = \frac{{r}_{{i}^{′}}^{o} - {m}_{{q}^{′}}}{{α}_{{i}^{′}}} , \qquad ( Equation 96 )$$

$$and$$

$${\sum }_{i} {L}_{q} ( {r}_{i}^{o} - {α}_{i} β ) = {\sum }_{i} {L}_{i} ⋅ ( {r}_{i}^{o} - {α}_{i} \frac{{r}_{{i}^{′}}^{o} - {m}_{{q}^{′}}}{{α}_{{i}^{′}}} ) . \qquad ( Equation 97 )$$

The objective is then to find the

$$β = \frac{{r}_{{i}^{′}}^{o} - {m}_{{q}^{′}}}{{α}_{{i}^{′}}}$$

that minimizes this sum.

### Optimizing Using Coordinate Descent (CD Method)

The Coordinate Descent (CD) method involves optimizing for each unknown at a time while fixing the other unknowns, and then rotating over the unknowns until a (local) minimum is found. This process may be repeated from another starting point in order to find other local minima or the global minimum if the starting point is close to it.

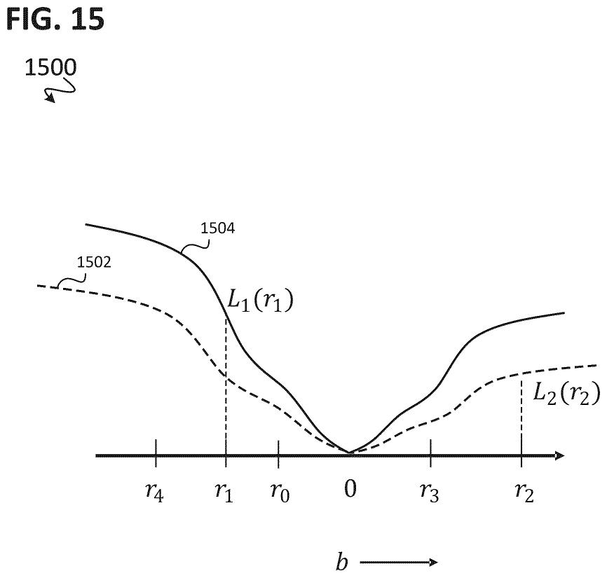

For a hypothesis on a grid point x, y, z, all residuals are only functions of the unknown b. In this case, the set of residuals rᵢ appears like a fixed pattern of points that need to be slid by a value of b until ΣL_{q}(rᵢ) is minimized. This means that the delta between any two residuals, rᵢ−r_{i′} is equal to a constant. Such residuals are illustrated in the plots 1500 of FIG. 15, which shows plots 1502 and 1504 of two example loss functions with respect to residuals for a grid point, having translated each by a corresponding m_{q} such that the location parameter appears at 0. The residuals are shifted by an amount b but the pattern does not change and the loss functions, e.g., 1502 and 1504, are not shifted (or vice versa, the loss functions, e.g., 1502 and 1504, could be shifted, but the residuals could be maintained unchanged). The cost function is evaluated by obtaining the loss value for each residual and then summing. When the residuals are shifted by b, this sum changes. The objective is to find the minimum for a fixed grid point (x, y, z).

Alternatively, y, z, b may be fixed and x may be slid until the minimum is found, and so on. However, this normally requires linearizing dᵢ in a small area. By linearizing dᵢ in a small area around a particular initial guess, x^{o}=(x^{o}, y^{o}, z^{o}, b^{o}), the residuals may be expressed as,

$$( Equation 98 )$$

$${r}_{i} ( x , y , z , b ) = {ρ}_{i} - {d}_{i}^{o} - {b}^{o} - {a}_{i}^{x} Δ x - {a}_{i}^{y} Δ y - {a}_{i}^{z} Δ z - Δ b \hat{=} {ρ}_{i} - {d}_{i}^{o} - {b}^{o} - {a}_{i}^{T} Δ x \hat{=} {r}_{i}^{o} - {a}_{i}^{T} Δ x .$$

where vector aᵢ=(aᵢ^{x}, aᵢ^{y}, aᵢ^{z}, 1)^{T}, and vector Δx=(Δx, Δy, Δz, b)^{T} is a displacement Δx=x−x^{o}, and x=(x, y, z, b)^{T} is the unknown. Thus,

$${a}_{i} = ( \frac{{x}^{o} - {x}_{i}}{{d}_{i}^{o}} , \frac{{y}^{o} - {y}_{i}}{{d}_{i}^{o}} , \frac{{z}^{o} - {z}_{i}}{{d}_{i}^{o}} , 1 ) , \qquad ( Equation 99 )$$

with dᵢ^{o} the distance from the initial guess x^{o} to anchor i. Note that aᵢ is the gradient of rᵢ with respect to x, at point x^{o}. If the superscript o is dropped, then it is the gradient at point x, more generally. The gradient is denoted by: ∇rᵢ=aᵢ. Also note that b=b^{o}+Δb but b may be directly referred to, or set b^{o}=0, since it's already linear. Also defined is aᵢ^{b} [symbol] 1.

When 3 parameters are fixed in x except one such as x, the residual may be expressed as

$${r}_{i} = {r}_{i}^{o} - {a}_{i}^{x} Δ x , \qquad ( Equation 100 )$$

where aᵢ^{x} is a constant, and Δx is the variable to be determined. When fixing x, y, z and varying b, the residual may be expressed as

$${r}_{i} = {r}_{i}^{o} - b , \qquad ( Equation 101 )$$

where b or Δb is a variable to be determined.

The previous section showed how to find the minimum of the sum of the loss functions for these cases. Generally, it is enough to use a quick search at each location parameter m_{q}, or at each positive step derivative point, check if the sum of the derivatives crosses zero (from negative to positive unless there is a sign inversion of the derivative), and if so, compute the sum of loss functions at this point. Then the minimum of the sum of loss functions as computed over the set of points is selected.

After solving for x or b, the process may proceed to another unknown parameter in x, and so on, and then repeat for x until convergence to a point is reached, which is usually a local minimum or the global minimum. However, except for estimating b, the region where the linearized distance applies may be small in terrestrial positioning systems because distances to the transmitters (anchors) can be small. Therefore, for the coordinates such as x, it may not be desirable to move too far from the initial guess x^{o} where linearity does not hold. Instead, it may be desirable to move slowly along the gradient and ensure the loss function is decreasing. Then the gradient may be recomputed and the process may continue moving in small steps (without necessarily checking the positive step derivative points unless one is crossed for one of the observations).

The CD method is very efficient if used with a grid of points for (x, y, z), and for each point in the grid, the CD is used to find b. Then, a few of the grid points are selected that exhibit a low-cost value for the cost function, and starting from each, the process may optionally proceed according to the Gradient Descent (GD) method in the following section.

### Optimizing Using Gradient Descent (GD)

For piecewise linear loss functions, i.e., having a multi-step function derivative, near a given point x^{o}, the derivative of the loss function can be written, for residuals rᵢ(x)=rᵢ^{o}−aᵢ^{T}Δx, with respect to x, as

$${\sum }_{i} {ϕ}_{q} ( {r}_{i} ( x ) ) ∇ {r}_{i} = {\sum }_{i} - {ϕ}_{q , j} {a}_{i}^{T} \hat{=} \overline{a} , \qquad ( Equation 102 )$$

with rᵢ=rᵢ^{o}−aᵢ^{T}Δx∈S_{q,j}, and ϕ_{q,j}=L′_{q,j} as given previously.

To minimize the loss function, it is desirable to move in the direction of Δx=μā. Therefore, rᵢ=rᵢ^{o}−aᵢ^{T}Δx=rᵢ^{o}−μaᵢ^{T}ā. This is similar to the coordinate descent, with μ being the parameter to optimize. The displacement μ should remain small, in the vicinity of the region where the gradient remains valid as previously discussed for the geographical coordinates of the CD method. Without necessarily reaching the next location parameter m_{q′}, the process may stop after a short displacement along the line Δx=μā, and then reapply linearization.

The main difference with the coordinate descent process as compared to the gradient descent process is that the gradient descent process traverses in the direction of the gradient with respect to all unknowns (i.e., x, y, z, b), following Δx=μā, thus adjusting all unknowns simultaneously while the coordinate descent optimizes each unknown at a time given other unknowns that are fixed. If it is decided to move using longer steps, perhaps reaching the next set of m_{q′}, the value of the loss function may need to be revalidated (if it decreases) by replacing the linear approximation of distances with precisely updated (non-linear) distances.

### Extension to TOT CSI

A multilateration process denoted as Time of Transmission Constrained Spherical Interpolation (TOT CSI) was described in U.S. patent application Ser. No. 17/769,815 (“the '815 patent”), all of which is incorporated herein in its entirety for all purposes. The TOT CSI process does not use a linearization near an initial guess. Instead, the TOT CSI process works globally and may be able to directly find the global minimum, or at least reduce the density of local minima. It may be less useful to estimate b, which can be directly estimated as a linear parameter as mentioned above, using the CD method applied to b after each step below. It is more useful to estimate x, y, z, even when a good initial guess is not available.

A given residual may be formulated as,

$${d}_{i} + ( b - {ρ}_{i} ) = - {n}_{i} , \qquad ( Equation 103 ) .$$

$$\to [ {d}_{i} + ( b - {ρ}_{i} ) ] [ {d}_{i} - ( b - {ρ}_{i} ) ] = - [ {d}_{i} - ( b - {ρ}_{i} ) ] {n}_{i} ,$$

$$\to {d}_{i}^{2} - {( b - {ρ}_{i} )}^{2} = ( b - {ρ}_{i} - {d}_{i} ) {n}_{i} ,$$

i.e.,

$${( x - {x}_{i} )}^{2} + {( y - {y}_{i} )}^{2} + {( z - {z}_{i} )}^{2} - {( b - {ρ}_{i} )}^{2} = ( b - {ρ}_{i} - {d}_{i} ) {n}_{i} , \qquad ( Equation 104 )$$

That is, the noise nᵢ, or the noise estimate or residual rᵢ=\hat{n}ᵢ, is scaled by (b−ρᵢ−dᵢ), as if the noise has been “inflated” or “deflated”, and where the noise scaling changes per iteration. Note that for weak noise, dᵢ≈−(b−ρᵢ), and therefore the scaling of nᵢ is roughly −2dᵢ. The effective residual, however, is still rᵢ=\hat{n}ᵢ and it is still an objective to minimize ΣᵢL_{q}(rᵢ) as stated previously. A scaled residual may be defined as,

$${r}_{i}^{s} = ( b - {ρ}_{i} - {d}_{i} ) {r}_{i} , \qquad ( Equation 105 )$$

but

$${\sum }_{i} {L}_{q} ( {r}_{i} ) = {\sum }_{i} {L}_{q} ( \frac{{r}_{i}^{s}}{( b - {ρ}_{i} - {d}_{i} )} ) , \qquad ( Equation 106 )$$

still needs to be minimized.

The '815 patent application mentioned above provides an Iterative Reweighted Least Squares solution (IRLS) method, in which a dummy (intermediate) variable u=x²+y²+z²−b² is defined, and a constrained linear problem is solved in each iteration of the IRLS. In the next iteration, weights are updated and an iteration is re-run, until convergence. The IRLS with a constrained linear problem assumes by default the residual is rᵢ^{s}, hence, a weight or scaling of

$$\frac{1}{( b - {ρ}_{i} - {d}_{i} )}$$

is included in order to optimize for the original residual rᵢ. For example, for Least Squares (LS),

$${\sum }_{i} {r}_{i}^{2} = {\sum }_{i} \frac{{( {r}_{i}^{s} )}^{2}}{{( b - {ρ}_{i} - {d}_{i} )}^{2}} , \qquad ( Equation 107 )$$

is the equivalent to using a weight of

$${w}_{i}^{LS} = \frac{1}{{( b - {ρ}_{i} - {d}_{i} )}^{2}} , \qquad ( Equation 108 )$$

and a summation of

$${\sum }_{i} {{w}_{i}^{LS} ( {r}_{i}^{s} )}^{2} . \qquad ( Equation 109 )$$

(hence a weighted LS).

The IRLS with a constrained linear problem can likewise be applied to the type of loss functions described in this application. In this case, the weights for each iteration are set to

$${w}_{q , i} = \frac{{L}_{q} ( {r}_{i} )}{{( {r}_{i}^{s} )}^{2}} = \frac{{L}_{q} ( \frac{{r}_{i}^{s}}{( b - {ρ}_{i} - {d}_{i} )} )}{{( {r}_{i}^{s} )}^{2}} . \qquad ( Equation 110 )$$

That is, within a Least Squares iteration, the Least Squares of the residuals are “undone” and replaced by the loss function of the residual. Hence,

$${\sum }_{i} {{w}_{q , i} ( {r}_{i}^{s} )}^{2} = {\sum }_{i} {L}_{q} ( {r}_{i} ) , \qquad ( Equation 111 )$$

as desired. However, IRLS may not have the best convergence properties. To improve convergence, the iterations may alternate between solving for clock bias using a linear system (the previously described CD method), and the above IRLS for solving for position and clock bias, as explained in the '815 patent. Furthermore, the process may be reiterated by trying different initial guesses, suitably selected (e.g., selected from a grid or equivalent).

An alternative approach, provided herein, uses a direct gradient descent (GD) method without weighted LS. The solution is relatively similar to the coordinate or gradient descent above but with the squared quantities.

### Gradient Descent Method for TOT CSI

The loss function,

$${\sum }_{i} {L}_{q} ( {r}_{i} ( x ) ) = {\sum }_{i} {L}_{q} ( \frac{{r}_{i}^{s} ( x )}{( b - {ρ}_{i} - {d}_{i} )} ) , \qquad ( Equation 112 )$$

has a gradient with respect to x, assuming an approximately constant scale (b−ρᵢ−dᵢ) and assuming a step function for the derivative of the loss function, given by

$${\sum }_{i} {ϕ}_{q} ( \frac{{r}_{i}^{s} ( x )}{( b - {ρ}_{i} - {d}_{i} )} ) ∇ {r}_{i}^{s} = {\sum }_{i} \frac{2 {ϕ}_{q , j}}{( b - {ρ}_{i} - {d}_{i} )} {a}_{i}^{′T} {=}^{Δ} {\overline{a}}^{′} , \qquad ( Equation 113 )$$

with vector

$${a}_{i}^{′ T} = ( x - {x}_{i} , y - {y}_{i} , z - {z}_{i} , - ( b - {ρ}_{i} ) ) , \qquad ( Equation 114 )$$

and the overall gradient

$${\overline{a}}^{′} {=}^{Δ} ( {a}^{′ x} , {a}^{′ y} , {a}^{′ z} , {a}^{′ b} ) . \qquad ( Equation 115 )$$

Starting from some point, x^{o}, an objective is to move on a line along the gradient ā′, i.e. Δx=μā′. However, as explained above, the gradient method normally relies on small steps since the gradient ā′ changes after some displacement, especially due to the scale

$$\frac{1}{( b - {ρ}_{i} - {d}_{i} )} .$$

Nevertheless, it's still possible to check for a potential minimum at one of the L_{q′} along the line of ā′. Unlike the case where the distance is linearized, in TOT CSI the formula remains valid over a wide range. One of the residuals, r_{i′}, may be expressed as,

$${r}_{i′} = ( b - {ρ}_{i} - {d}_{i} ) {r}_{{i}^{′}} = ( b - {ρ}_{i} - {d}_{i} ) {m}_{q′} = {( x + {a}^{′ x} μ - {x}_{i′} )}^{2} + {( y + {a}^{′ y} μ - {y}_{i} )}^{2} + {( z + {a}^{′ z} μ - {z}_{i′} )}^{2} - {( b + {a}^{′ b} μ - {ρ}_{{i}^{′}} )}^{2} , \qquad ( Equation 116 )$$

with the scale (b−ρᵢ−dᵢ) assumed to be constant. The second-order polynomial in μ may provide an approximate solution (an intersection of the gradient line with a hyper-cone). If a solution, μ is found to the second order polynomial, x=x^{o}+μā′ may be updated. Then the distances dᵢ and the loss function value may be updated. If the loss function value is below the previous one, the procedure is successful. If not, the same process may be tried for other residuals r_{i′}. If none of them are successful at reducing the loss function, moving with a small step μ may be tried. The procedure is reiterated until the solution stabilizes.

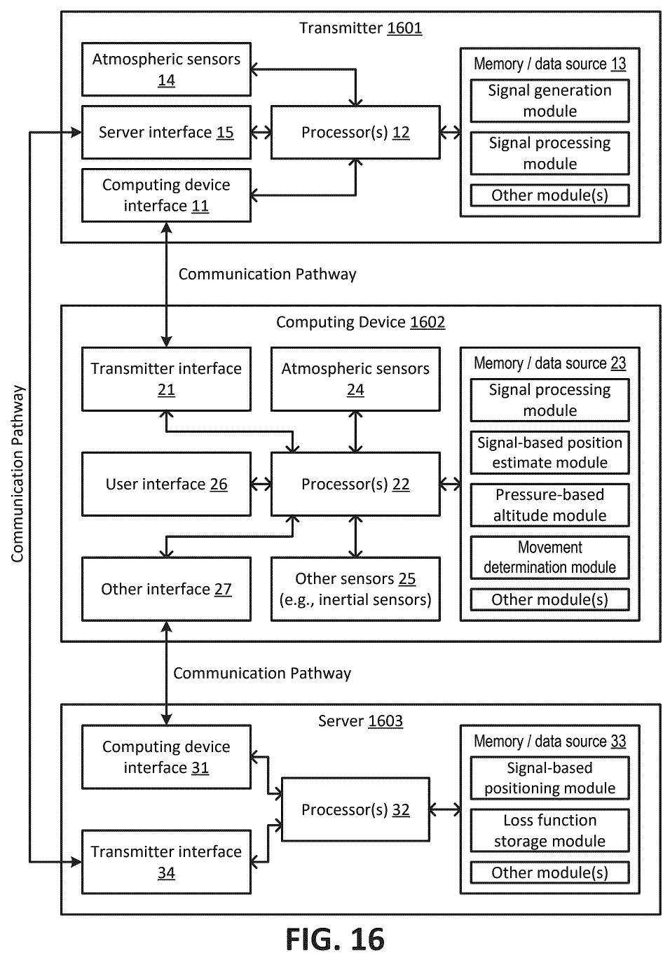

FIG. 16 illustrates components of an example transmitter 1601 (e.g., one of the transmitters 110a-c), an example computing device 1602 (e.g., one of the computing devices 120a-b), and an example server 1603 (e.g., any one of the servers 130). Examples of communication pathways are shown by arrows between components. The components shown in FIG. 16 are operable to perform all or a portion of the process 200 and are non-limiting. That is, each of the components 1601, 1602, and 1603 may include additional, fewer, or other modules than described herein.

By way of example in FIG. 16, each of the transmitters 1601 may include a computing device interface 11 for exchanging information with a computing device (e.g., antenna(s) and RF front-end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the transmitter; a server interface 15 for exchanging information with a server (e.g., an antenna, a network interface, or other); and any other components known to one of ordinary skill in the art. The memory/data source 13 may include a memory storing software modules with executable instructions, and the processor(s) 12 may perform different actions by executing the instructions from the modules, including (i) performance of a part or all of the methods as described herein or otherwise understood by one of skill in the art as being performable at the transmitter; (ii) generation of positioning signals for transmission using a selected time, frequency, code, and/or phase; (iii) processing of signals received from the computing device or another source; or (iv) other processing as required by operations described in this disclosure. Signals generated and transmitted by a transmitter may carry different information that, once determined by a computing device or a server, may identify the following: the transmitter; the transmitter's position; environmental conditions at or near the transmitter; and/or other information known in the art. The atmospheric sensor(s) 14 may be integral with the transmitter, or separate from the transmitter and either co-located with the transmitter or located in the vicinity of the transmitter (e.g., within a threshold amount of distance).

By way of example in FIG. 16, the computing device 1602 may include a transmitter interface 21 for exchanging information with a transmitter (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the computing device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; another interface 27 for exchanging information with the server or other devices external to the computing device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the computing device; (ii) estimation of an altitude of the computing device based on measurements of pressure from the computing device and transmitter(s), temperature measurement(s) from the transmitter(s) or another source, and any other information needed for the computation); (iii) processing of received signals to determine position information (e.g., times of arrival or travel time of the signals, pseudoranges between the computing device and transmitters, transmitter atmospheric conditions, transmitter and/or locations or other transmitter information); (iv) use of position information to compute an estimated position of the computing device; (v) determination of movement based on measurements from inertial sensors of the computing device; (vi) GNSS signal processing; or (vii) other processing as required by operations described in this disclosure.

By way of example in FIG. 16, the server 1603 may include a computing device interface 31 for exchanging information with a computing device (e.g., an antenna, a network interface, or other); one or more processor(s) 32; memory/data source 33 for providing storage and retrieval of information and/or program instructions; a transmitter interface 34 for exchanging information with a transmitter (e.g., an antenna, a network interface, or other); and any other components known to one of ordinary skill in the art. The memory/data source 33 may include a memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the computing device; (iii) computation of an estimated position of the computing device; or (iv) other processing as required by operations described in this disclosure. Steps performed by servers as described herein may also be performed on other machines that are remote from a computing device, including computers of enterprises or any other suitable machine.

Certain aspects disclosed herein relate to estimating the positions of computing devices—e.g., where the position is represented in terms of latitude, longitude, and/or altitude coordinates; x, y, and/or z coordinates; angular coordinates; or other representations. Various techniques to estimate the position of a computing device can be used, including trilateration, which is the process of using geometry to estimate the position of a computing device using distances traveled by different “positioning” (or “ranging”) signals that are received by the computing device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the computing device. Different estimated distances corresponding to different positioning signals from different beacons can be used along with position information like the locations of those beacons to estimate the position of the computing device. Positioning systems and methods that estimate the position of a computing device (in terms of latitude, longitude, and/or altitude) based on positioning signals from beacons (e.g., transmitters, and/or satellites) and/or atmospheric measurements are described in co-assigned U.S. Pat. No. 8,130,141, issued Mar. 6, 2012, and U.S. Pat. No. 9,057,606,issued Jun. 16, 2015, incorporated by reference herein in its entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
collecting, by one or more processors, first positioning data associated with multiple positioning data quality metrics within a region;
determining, by the one or more processors, one or more modeled loss functions associated with each positioning data quality metric using the collected first positioning data;
storing, by the one or more processors, the one or more modeled loss functions at a database;
determining, by the one or more processors, a first estimated position of a computing device using second positioning data;
retrieving from the database, by the one or more processors, a modeled loss function of the one or more modeled loss functions, the retrieved modeled loss function being associated with a positioning data quality metric associated with the second positioning data;
performing, by the one or more processors, a first gradient descent process using the first estimated position and the retrieved modeled loss function to determine an estimated clock bias for the computing device; and
performing, by the one or more processors, a second gradient descent process using the first estimated position, the estimated clock bias, and the retrieved modeled loss function to determine a second estimated position for the computing device, the second estimated position being a more accurate estimated position of the computing device as compared to the first estimated position of the computing device.

2. The method of claim 1, wherein determining the one or more modeled loss functions comprises:
determining, by the one or more processors, empirically derived residuals for the region using the first positioning data collected for the region;
splitting, by the one or more processors, the residuals into residual subsets; and
for each residual subset, determining, by the one or more processors, a respective approximate piece-wise linear segment of a modeled loss function of the one or more modeled loss functions.

3. The method of claim 2, wherein determining the one or more modeled loss functions further comprises:
for each residual subset, determining, by the one or more processors, the respective approximate piece-wise linear segment of the modeled loss function for inner segments of the modeled loss function; and
determining, by the one or more processors, respective piece-wise constant function segments of the modeled loss function for outer segments of the modeled loss function.

4. The method of claim 1, wherein determining the one or more modeled loss functions comprises:
determining, by the one or more processors, empirically derived residuals for the region using the first positioning data collected for the region;
splitting, by the one or more processors, the residuals into a plurality of residual subsets; and
for each residual subset, determining, by the one or more processors, a respective approximate piece-wise polynomial segment of a plurality of polynomial segments of a modeled loss function of the one or more modeled loss functions.

5. The method of claim 4, wherein:
each piece-wise polynomial segment of the plurality of polynomial segments is optimized, by the one or more processors, by minimizing a total cost for the residuals subject to a constraint, the constraint being that the area under a probability distribution function corresponding to the modeled loss function is equal to 1.

6. The method of claim 5, wherein:
each piece-wise polynomial segment of the plurality of polynomial segments is optimized independently of the other piece-wise polynomial segments of the plurality of polynomial segments.

7. The method of claim 1, wherein determining the one or more modeled loss functions comprises:
determining, by the one or more processors, empirically derived residuals for the region using the first positioning data collected for the region;
splitting, by the one or more processors, the residuals into residual subsets; and
determining, by the one or more processors, an intermediate modeled loss function based on a Maximum Likelihood process comprising:
grouping the empirically derived residuals into a plurality of residual sets based on a quality metric associated with each residual;
determining a plurality of respective intermediate modeled loss functions corresponding to the plurality of residual sets; and
optimizing the plurality of respective intermediate modeled loss functions to generate the modeled loss function of the one or more modeled loss functions.

8. The method of claim 7, wherein:
the plurality of respective intermediate modeled loss functions are optimized according to a constraint, the constraint being that a respective area below a probability function of each intermediate modeled loss function is equal to 1.

9. The method of claim 1, wherein determining the one or more modeled loss functions comprises:
determining, by the one or more processors, empirically derived residuals for the region using the first positioning data collected for the region;
splitting, by the one or more processors, the residuals into residual subsets; and
for each residual subset:
determining, by the one or more processors, a first approximate piece-wise segmentation of a modeled loss function of the one or more modeled loss functions;
assigning, by the one or more processors, the residuals of the residual subset to a corresponding piece-wise segment of the modeled loss function;
optimizing, by the one or more processors, the first piece-wise segmentation, independently per segment; and
iteratively determining, by the one or more processors, an intersection between pairs of piece-wise segments until acceptable continuity between piece-wise segments is achieved.

10. The method of claim 9, further comprising:
grouping, by the one or more processors, the empirically derived residuals based on one or more criteria to generate a plurality of residual bins;
calculating, by the or more processors, a cumulative distribution function (CDF) for each residual bin of the plurality of residual bins; and
estimating, by the one or more processors, a shape of the modeled loss function using the calculated CDF.

11. The method of claim 9, wherein:
the modeled loss function comprises i) first and second regions, each having a negative second derivative, and ii) an abrupt change at a minima between the first and second regions.

12. The method of claim 9, wherein:
the modeled loss function comprises i) first and second regions, each having a negative second derivative, and ii) a minima region modeled by piecewise linear segments.

13. The method of claim 9, wherein:
the modeled loss function comprises i) first and second regions, each having a negative second derivative, and ii) a minima region modeled by a smooth transition.

14. A method comprising:
collecting, by one or more processors, first positioning data associated with multiple positioning data quality metrics within a region;
determining, by the one or more processors, one or more modeled loss functions associated with each positioning data quality metric using the collected first positioning data;
storing, by the one or more processors, the one or more modeled loss functions at a database;
determining, by the one or more processors, a first estimated position of a computing device using second positioning data;
retrieving from the database, by the one or more processors, a modeled loss function of the one or more modeled loss functions, the retrieved modeled loss function being associated with a positioning data quality metric associated with the second positioning data; and
determining, by the one or more processors, a second estimated position for the computing device using the retrieved modeled loss function, the second estimated position being a more accurate estimated position of the computing device as compared to the first estimated position of the computing device.

15. The method of claim 14, wherein determining the one or more modeled loss functions comprises:
determining, by the one or more processors, empirically derived residuals for the region using the first positioning data collected for the region;
splitting, by the one or more processors, the residuals into residual subsets; and
for each residual subset, determining, by the one or more processors, a respective approximate piece-wise linear segment of a modeled loss function of the one or more modeled loss functions.

16. The method of claim 14, wherein determining the one or more modeled loss functions further comprises:
determining, by the one or more processors, empirically derived residuals for the region using the first positioning data collected for the region;
splitting, by the one or more processors, the residuals into a plurality of residual subsets; and
for each residual subset, determining, by the one or more processors, a respective approximate piece-wise polynomial segment of a plurality of polynomial segments of a modeled loss function of the one or more modeled loss functions.

17. The method of claim 14, wherein determining the one or more modeled loss functions comprises:
determining, by the one or more processors, empirically derived residuals for the region using the first positioning data collected for the region;
splitting, by the one or more processors, the residuals into residual subsets; and
determining, by the one or more processors, an intermediate modeled loss function based on a Maximum Likelihood process comprising:
grouping the empirically derived residuals into a plurality of residual sets based on a quality metric associated with each residual;
determining a plurality of respective intermediate modeled loss functions corresponding to the plurality of residual sets; and
optimizing the plurality of respective intermediate modeled loss functions to generate the modeled loss function of the one or more modeled loss functions.

18. The method of claim 14, wherein determining the one or more modeled loss functions comprises:
determining, by the one or more processors, empirically derived residuals for the region using the first positioning data collected for the region;
splitting, by the one or more processors, the residuals into residual subsets; and
for each residual subset:
determining, by the one or more processors, a first approximate piece-wise segmentation of a modeled loss function of the one or more modeled loss functions;
assigning, by the one or more processors, the residuals of the residual subset to a corresponding piece-wise segment of the modeled loss function;
optimizing, by the one or more processors, the first piece-wise segmentation, independently per segment; and
iteratively determining, by the one or more processors, an intersection between pairs of piece-wise segments until acceptable continuity between piece-wise segments is achieved.

19. The method of claim 18, wherein:
the modeled loss function comprises i) first and second regions, each having a negative second derivative, and ii) an abrupt change at a minima between the first and second regions.

20. The method of claim 18, wherein:
the modeled loss function comprises i) first and second regions, each having a negative second derivative, and ii) a minima region modeled by piecewise linear segments.

21. The method of claim 18, wherein:
the modeled loss function comprises i) first and second regions, each having a negative second derivative, and ii) a minima region modeled by a smooth transition.
